(19) United States
(12) Patent Application Publication
(10) Pub. No.: US 2026/0049202 A1
(43) Pub. Date: Feb. 19, 2026

(54) SILANE COMPOUND AND COMPOSITIONS CONTAINING SAME

(71) Applicant: SYNTHOMER SDN BHD, Johor Darul Takzim (MY)

(72) Inventors: Zhenli WEI, Kulai, Johor (MY); Chi Hoong CHAN, Kulai, Johor (MY); Yi-fan GOH, Kulai, Johor (MY)

(73) Assignee: SYNTHOMER SDN BHD, Johor Darul Takzim (MY)

(21) Appl. No.: 19/126,519

(22) PCT Filed: Oct. 18, 2023
(86) PCT No.: PCT/MY2023/050083

§ 371 Date: May 1, 2025

(30) Foreign Application Priority Data
Nov. 15, 2022 (MY) PI 2022006433

(51) Int. Cl. C08K 5/5435; B29C 41/00; B29C 41/14; B29C 71/02; B29K 105/00; B29K 105/24; C08J 5/18; C08L 15/00

(52) U.S. Cl. CPC C08K 5/5435; B29C 41/003; B29C 41/14; B29C 71/02; C08J 5/18; C08L 15/00; B29K 2105/0064; B29K 2105/24; C08J 2315/00; C08L 2201/52; C08L 2203/16; C08L 2312/08

(57) ABSTRACT

The present invention relates to a polymer latex composition, to a method for the preparation of such polymer latex composition, to the use of said polymer latex composition, to a compounded latex composition comprising said polymer latex composition, to a method for making dip-molded articles, to a method for making elastomeric films and articles, to a method for repairing of reforming an elastomeric film or article and to articles made by using said polymer latex composition.

The present invention relates to a polymer latex composition, to a method for the preparation of such polymer latex composition, to the use of said polymer latex composition, to a compounded latex composition comprising said polymer latex composition, to a method for making dip-molded articles, to a method for making elastomeric films and articles, to a method for repairing of reforming an elastomeric film or article and to articles made by using said polymer latex composition.

### BACKGROUND OF THE INVENTION

In the art of making articles based on a polymer latex it is in general desired to achieve a high tensile strength and at the same time high elongation of the film forming the article to provide high mechanical strength and desired softness to the article. This is particularly important for gloves such as surgical gloves. Furthermore, in the recent past it was discovered that a growing number of persons show allergic reactions to latex based articles, for example a natural rubber latex that has been used commonly in the past in the manufacturing of latex products such as dip molded product containing up to 5% of non-rubber components such as proteins, lipids and trace elements. Users of natural rubber latex products have developed Type-I hypersensitivity which is caused by the residual extractable latex proteins present in natural rubber products.

Natural as well as artificially made polymer latices are commonly crosslinked using a sulfur vulcanization system including sulfur and sulfur-containing accelerators. The use of these sulfur vulcanization systems in rubber gloves manufacturing can give rise to the delay Type-IV hypersensitivity such as allergic contact dermatitis.

As a result, it is desirable to avoid sulfur vulcanization systems and particularly to provide polymer latices that can be used for the manufacture of dip-molded articles that do not need the standard sulfur vulcanization systems including the sulfur-containing accelerators previously used therein in order to obtain the desired mechanical properties of the final product.

Other commonly known crosslinkers may provide the desired mechanical properties, but often cause shorter shelf life of the compositions, which can be remedied by using high amounts of these crosslinkers. However, this causes higher costs and may even lead to lower tensile and durability performances of the final products derived from the polymer latex compositions.

It is thus the object of the present invention to provide hydrolytically stable polymer latex compositions having increased self-life while maintaining the advantageous mechanical properties of the final product such as good force at break (FAB), tensile strength (TS) and elongation break (EB) and also providing high durability performance even after 6 months.

### SUMMARY OF THE INVENTION

The following clauses summarize some aspects of the present invention.

According to a first aspect, the present invention relates to a polymer latex composition for the preparation of elastomeric films comprising:
(a) particles of a latex polymer obtained by free-radical emulsion polymerization of a composition comprising ethylenically unsaturated monomers, the latex polymer comprising a functional group (A); and
(b) a silane compound selected from the compounds of Formula I, II, oligomers thereof or combinations of any of the foregoing:

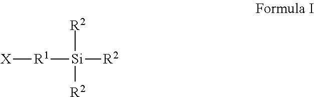

wherein
X is a functional group capable to form a bond with the functional group (A) of the latex polymer (a);
R¹ is a linking group between the functional group X and the silicon atom or R¹ is a bond;
R² independently is a hydrolysable group or a non-hydrolysable group;
wherein at least one of R² is a hydrolysable group and at least one of R² is a non-hydrolysable group;
   wherein

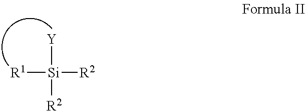

Y is O, S, NH or NR³; wherein R³ is a linear or branched, substituted or unsubstituted alkyl or alkenyl;
R¹ is a linking group between the functional group Y and the silicon atom;
R² independently is a hydrolysable group or a non-hydrolysable group;
wherein at least one of R² is a non-hydrolysable group.

The Si—Y bond may be hydrolysable forming a Si—OH group and a Y—H group, wherein the Y—H group is a functional group capable to form a bond with the functional group (A) of the latex polymer (a).

The polymer latex composition may comprise the silane compound (b) in an amount of from 0.10 to 4.00 parts by weight; preferably from 0.20 to 2.00 parts by weight, more preferably from 0.20 to 1.80 parts by weight, even more preferably from 0.20 to 1.50 parts by weight; most preferably from 0.40 to 1.50 parts by weight; based on 100 parts by weight of latex polymer (a).

Preferably, each non-hydrolysable R² independently is a linear C₁ to C₂₀ alkyl, a linear C₂-C₂₀ alkenyl, a branched or cyclic C₃-C₂₀ alkyl or alkenyl or an aryl, more preferably a linear C₁-C₂₀alkyl.

Preferably, each hydrolysable R² independently is —H, —OR′, —OC(O)CH₃, —OCH₂OCH₃, —SR′, —NHR′, —NR′₂, -halogen, wherein R′ is a linear C₁-C₆ alkyl, a branched C₃-C₆ alkyl or alkenyl, or an aryl; more preferably each hydrolysable R² independently is —OR′, or -halogen, wherein R′ is a linear C₁-C₆ alkyl, a branched C₃-C₆ alkyl or alkenyl, or an aryl.

The linking group R¹ between the functional group X and the silicon atom may be a linear C₁-C₂₀ alkanediyl, a branched C₂-C₂₀ alkanediyl, a cyclic C₃-C₂₀ alkanediyl or alkenediyl, or arylenediyl; preferably a linear C₁-C₂₀ alkanediyl, wherein optionally one or more methylene group(s) in each of the above alkanediyl, alkenediyl and arylenediyl is/are replaced by a heteroatom, provided that no heteroatom is directly bonded to another heteroatom and no heteroatom is directly bonded to Si, wherein the heteroatom preferably is oxygen, sulphur, or nitrogen, more preferably oxygen.

The linking group R¹ between the functional group Y and the silicon atom may be a linear or branched C₃-C₂₀ alkanediyl; preferably a linear or branched C₃-C₁₀ alkanediyl, wherein optionally one or more methylene group(s) in each of the above alkanediyl is/are replaced by a heteroatom, provided that no heteroatom is directly bonded to another heteroatom and no heteroatom is directly bonded to Si, wherein the heteroatom preferably is oxygen, sulphur, or nitrogen, more preferably oxygen.

The functional group X may be selected from the group consisting of carbon-carbon double bond, (meth)acryloxy, halide functional group, epoxy, glycidyl, thiol, hydroxy, hydroxylamine, primary amino, secondary amino, isocyanato, oxazolino, aziridino, imino, carbodiimido, glycol, ester, acetoxy, acetoacetoxy, carboxylic acid, dioxolanone, hydrazido, aldehyde, boronic acid, alkoxysilyl and ketone; preferably from the group consisting of carbon-carbon double bond, (meth)acryloxy, halide functional group, glycidyl, epoxy, thiol, hydroxy, primary amino, secondary amino, and isocyanato; more preferably from the group consisting of glycidyl, epoxy, thiol, hydroxy, primary amino and secondary amino.

The silane compound (b) may be selected from the group consisting of (3-glycidoxypropyl) methyl diethoxysilane, (3-glycidoxypropyl) dimethyl ethoxysilane, (3-glycidoxypropyl) methyl dimethoxysilane, 2-(3,4-epoxycyclohexyl)ethyl methyl diethoxysilane, 3-aminopropyl dimethyl methoxysilane, 3-aminopropyl dimethyl ethoxysilane, 3-aminopropyl methyl diethoxysilane, 3-aminopropyl diisopropyl ethoxysilane, 4-amino-3,3-dimethylbutyl methyl dimethoxysilane, (1-aminopropan-2-yl) ethoxy dimethylsilane, N-(2-aminoethyl)-3-aminopropyl methyl diethoxysilane, N-(2-aminoethyl)-3-aminoisobutyl dimethyl methoxysilane, N-(2-aminoethyl)-3-aminopropyl methyl dimethoxysilane, N-(2-aminoethyl)-3-aminoisobutyl methyl dimethoxysilane, (N-cyclohexylaminomethyl) methyl diethoxysilane, N-methylaminopropyl methyl dimethoxysilane, (phenylaminomethyl) methyl dimethoxysilane, 3-(N,N-dimethylaminopropyl)aminopropyl methyl dimethoxysilane, (3-acryloxypropyl) methyl diethoxysilane, (3-acryloxypropyl) methyl dimethoxysilane, (3-acryloxypropyl) dimethyl methoxysilane, (methacryloxymethyl) methyl diethoxysilane, (methacryloxymethyl) methyl dimethoxysilane, (methacryloxymethyl) dimethyl ethoxysilane, (methacryloxypropyl) dimethyl methoxysilane, allylmethyldimethoxysilane, vinylmethyldiethoxysilane, vinylmethyldimethoxysilane, vinyldimethylethoxysilane, (5-bicyclo[2.2.1]hept-2-enyl) methyl diethoxysilane, (5-bicyclo[2.2.1]hept-2-enyl) dimethyl ethoxysilane, (5-bicyclo[2.2.1]hept-2-enyl) methyl dichlorosilane, (mercaptomethyl) methyl diethoxysilane, 3-mercaptopropyl methyl dimethoxysilane, chloromethyl dimethyl ethoxysilane, ((chloromethyl)phenylethyl) methyl dimethoxysilane, 3-chloropropyl dimethyl ethoxysilane, 3-chloropropyl dimethyl methoxysilane, 3-chloroisobutyl dimethyl methoxysilane, chloromethyl dimethyl ethoxysilane, 3-chloropropyl methyl diisopropoxysilane, (3-iodopropyl) methyl diisopropoxysilane, 3-isocyanatopropyl methyl diethoxysilane, 3-isocyanatopropyl methyl dimethoxysilane, 1,1-dimethyl-1-sila-2-oxacyclohexane, 2,2,4-trimethyl-1-oxa-4-aza-2-silacyclohexane, 1-decyl-1-methyl-1-sila-2-oxacyclohexane, 2,2,4-trimethyl-1-thia-2-silacyclopentane, N-(2-aminoethyl)-2,2,4-trimethyl-1-aza-2-silacyclopentane, N-(3-aminopropyldimethylsilyl)aza-2,2-dimethyl-2-silacyclopentane, (N,N-dimethylaminopropyl)-aza-2-methyl-2-methoxysilacyclopentane, and combinations thereof.

The functional group (A) of the latex polymer (a) may be selected from the group consisting of carbon-carbon double bond, carboxylic acid, hydroxy, epoxy, glycidyl, acetoacetoxy, primary or secondary amino, acetoxy, isocyanato, alkoxysilyl, alkoxy, dioxolanone, halide functional group, thiol, hydroxylamine, oxazolino, aziridino, imino, carbodiimido, glycol, ester, hydrazido, aldehyde, ketone, and combinations thereof; preferably from the group consisting of carbon-carbon double bond, carboxylic acid, halide functional group, epoxy, glycidyl, thiol, hydroxy, primary or secondary amino, isocyanato, and combinations thereof; more preferably from the group consisting of carboxylic acid.

The bond formed between the functional group (A) of the latex polymer (a) and the functional group X of the silane compound (b) may be selected from the group consisting of disulfide, tetrasulfide, carbonate, urea, thiourea, ester, beta-hydroxy ester, thioester, beta-hydroxy amine, beta-hydroxy thioether, amide, urethane, enamine, imine, hemiacetal, acetal, hemiketal, ketal, boronate ester, siloxane, oxime, acylhydrazone, aldol, thiuram disulfide and trithiocarbonate.

The bond formed between the functional group (A) of the latex polymer (a) and the functional group Y—H of the silane compound (b) may be selected from disulfide, tetrasulfide, carbonate, urea, thiourea, ester, beta-hydroxy ester, thioester, amide, urethane, enamine, imine, hemiacetal, acetal, hemiketal, ketal, and boronate ester.

The polymer latex composition may further comprise a silane compound (c) different to silane compound (b), wherein the silane compound (c) is selected from the compounds of Formula III, IV, oligomers thereof or combinations of any of the foregoing:

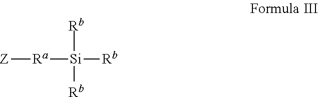

wherein
Z is a functional group capable to form a bond with the functional group (A) of the latex polymer (a);
R^{a} is a linking group between the functional group Z and the silicon atom or R^{a} is a bond;
R^{b} is a hydrolysable group;

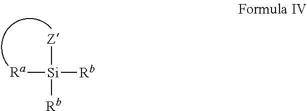

wherein
Z′ is O, S, NH or NR³; wherein R³ is a linear or branched, substituted or unsubstituted alkyl or alkenyl;
R^{a} is a linking group between the functional group Z′ and the silicon atom;
R^{b} is a hydrolysable group.

The Si—Z′ bond may be hydrolysable forming a Si—OH group and a Z′—H group, wherein the Z′—H group is a functional group capable to form a bond with the functional group (A) of the latex polymer (a).

Preferably, each hydrolysable R^{b} independently is —H, —OR′, —OC(O)Me, —OCH₂OCH₃, —SR′, —NHR′, —NR′₂, -halogen, wherein R′ is a linear C₁-C₆ alkyl, a branched C₃-C₆ alkyl or alkenyl, or an aryl; more preferably each hydrolysable R^{b} independently is —OR′, or -halogen, wherein R′ is a linear C₁-C₆ alkyl, a branched C₃-C₆ alkyl or alkenyl, or an aryl.

The linking group R^{a} between the functional group Z and the silicon atom may be a linear C₁-C₂₀alkanediyl, a branched C₂-C₂₀ alkanediyl, a cyclic C₃-C₂₀ alkanediyl or alkenediyl, or arylenediyl; preferably a linear C₁-C₂₀ alkanediyl; wherein optionally one or more methylene group(s) in each of the above alkanediyl, alkenediyl and arylenediyl is/are replaced by a heteroatom, provided that no heteroatom is directly bonded to another heteroatom and no heteroatom is directly bonded to Si, wherein the heteroatom preferably is oxygen, sulphur, or nitrogen, more preferably oxygen.

Preferably, the linking group R^{a} between the functional group Z′ and the silicon atom is a linear or branched C₃-C₂₀ alkanediyl; more preferably a linear or branched C₃-C₁₀ alkanediyl; wherein optionally one or more methylene group(s) in each of the above alkanediyl, alkenediyl and arylenediyl is/are replaced by a heteroatom, provided that no heteroatom is directly bonded to another heteroatom and no heteroatom is directly bonded to Si, wherein the heteroatom preferably is oxygen, sulphur, or nitrogen, more preferably oxygen.

The functional group Z may be selected from the group consisting of carbon-carbon double bond, (meth)acryloxy, halide functional group, epoxy, glycidyl, thiol, hydroxy, hydroxylamine, primary amino, secondary amino, isocyanato, oxazolino, aziridino, imino, carbodiimido, glycol, ester, acetoxy, acetoacetoxy, carboxylic acid, dioxolanone, hydrazido, aldehyde, boronic acid, alkoxysilyl and ketone; preferably from the group consisting of carbon-carbon double bond, (meth)acryloxy, halide functional group, epoxy, glycidyl, thiol, hydroxy, primary amino, secondary amino, and isocyanato; more preferably from the group consisting of glycidyl, epoxy, thiol, hydroxy, primary amino and secondary amino.

The mass ratio of the silane compound (c) and the silane compound (b) may be from 1:40 to 40:1, preferably 1:20 to 2:1, when the silane compound (c) is present.

The polymer latex composition may comprise the silane compound (b) and the silane compound (c) in a combined amount of from 0.10 to 5.00 parts by weight; preferably from 0.20 to 5.00 parts by weight; more preferably from 0.20 to 4.50 parts by weight; even more preferably from 0.20 to 4.00 parts by weight; based on 100 parts by weight of latex polymer (a).

The monomer composition to obtain the particles of a latex polymer (a) may comprise:
(i) 15 to 99 wt.-% of conjugated dienes;
(ii) 1 to 80 wt.-% of monomers selected from ethylenically unsaturated nitrile compounds;
(iii) 0 to 10 wt.-% of an ethylenically unsaturated compound different from (i) and (ii) comprising a functional group (A);
(iv) 0 to 80 wt.-% of vinyl aromatic monomers; and
(v) 0 to 65 wt.-% of alkyl esters of ethylenically unsaturated acids;
the weight percentages being based on the total weight of the ethylenically unsaturated monomers in the monomer composition.

It is envisaged that:
(i) the conjugated dienes may be selected from 1,3-butadiene, isoprene, 2,3-dimethyl-1,3-butadiene, 2-ethyl-1,3-butadiene, 1,3-pentadiene, 3,7,11-trimethyl-1,3,6,10-dodecatetraene, 7,11-dimethyl-3-methylene-1,6,10-dodecatriene, 7-methyl-3-methylene-1,6-octadiene, and combinations thereof;
(ii) the ethylenically unsaturated nitrile compounds may be selected from (meth)acrylonitrile, alpha-cyanoethyl acrylonitrile, fumaronitrile, alpha-chloronitrile and combinations thereof;
(iii) the ethylenically unsaturated compounds different from (i) and (ii) comprising a functional group (A) may be selected from
(iii1) ethylenically unsaturated compounds having at least two different ethylenically unsaturated groups, preferably selected from allyl(meth)acrylate, vinyl(meth)acrylate and combinations thereof;
(iii2) ethylenically unsaturated acids and salts thereof, preferably selected from (meth)acrylic acid, crotonic acid, itaconic acid, maleic acid, fumaric acid, ethylenically unsaturated sulfonic acids, ethylenically unsaturated phosphorous containing acids, polycarboxylic acid anhydride, polycarboxylic acid partial ester monomer, carboxy alkyl esters of ethylenically unsaturated acids and combinations thereof;
(iii3) hydroxy functional ethylenically unsaturated compounds, preferably selected from allyl alcohol, vinyl alcohol, N-methylolacrylamide, 1-penten-3-ol, hydroxyalkyl esters of ethylenically unsaturated acids and combinations thereof;
(iii4) epoxy functional ethylenically unsaturated compounds, preferably selected from vinyl cyclohexene oxide, limonene oxide, (3′,4′-epoxyheptyl)-2-ethyl (meth)acrylate, (6′,7′-epoxyheptyl)(meth)acrylate, allyl-3,4-epoxyheptylether, 6,7-epoxyheptylallylether, vinyl-3,4-epoxyheptylether, 3,4-epoxyheptylvinylether, 6,7-epoxyheptylvinylether, 3-vinyl cyclohexene oxide, 2-(3,4-epoxycyclohexyl)methyl (meth)acrylate, 3,4-epoxy-1-butene, 1,2-epoxy-5-hexene, 4-vinyl-1-cyclohexene 1,2-epoxide, 2-methyl-2-vinyloxirane, 3,4-epoxy-1-cyclohexene and combinations thereof;
(iii5) glycidyl functional ethylenically unsaturated compounds, preferably selected from glycidyl (meth)acrylate, allyl glycidylether, vinyl glycidylether, 2-ethylglycidyl (meth)acrylate, 2-(n-propyl)glycidyl (meth)acrylate, 2-(n-butyl)glycidyl (meth)acrylate, o-vinylbenzylglycidylether, m-vinylbenzylglycidylether, p-vinylbenzylglycidylether, alpha-methyl glycidyl methacrylate, glycidyl propargyl ether and combinations thereof;
(iii6) acetoacetoxy functional ethylenically unsaturated compounds, preferably selected from acetoacetoxyethyl (meth)acrylate, acetoacetoxypropyl (meth)acrylate, allyl acetoacetate, acetoacetoxybutyl (meth)acrylate, 2,3-di(acetoacetoxy)propyl (meth)acrylate, acetoacetoxy(methyl)ethyl (meth)acrylate, acetoacetamido-ethyl(meth)acrylate, 3-(methacryloyloxy)-2,2-dimethylpropyl 3-oxobutanoate, 3-(methacryloyloxy)-2,2,4,4-tetramethylcyclobutyl 3-oxobutanoate, 3-(methacryloyloxy)-2,2,4-trimethylpentyl 3-oxobutanoate, 1-(methacryloyloxy)-2,2,4-trimethylpentan-3-yl 3-oxobutanoate, (4-(methacryloyloxymethyl)cyclohexyl)methyl 3-oxobutanoate and combinations thereof;
(iii7) ethylenically unsaturated compounds bearing a primary or secondary amino group, preferably selected from (meth)acrylamide, 2-amino ethyl (meth)acrylate hydrochloride, 2-amino ethyl (meth)acrylamide hydrochloride, N-ethyl (meth)acrylamide, N-(3-amino propyl) (meth)acrylamide hydrochloride, N-hydroxyethyl (meth)acrylamide, N-3-(dimethylamino) propyl (meth)acrylamide, [3-(methacryloylamino)propyl]trimethylammonium, N-[tris(hydroxymethyl) methyl](meth)acrylamide, N-phenylacrylamide, alkylacrylamide, methacrylamide poly(ethylene glycol) amine hydrochloride and combinations thereof;
(iii8) acetoxy functional ethylenically unsaturated compounds, preferably selected from 1-acetoxy-1,3-butadiene, diacetoneacrylamide and combinations thereof;
(iii9) isocyanato functional ethylenically unsaturated compounds, preferably selected from 2-isocyanatoethyl(meth)acrylate, allyl isocyanate, vinyl isocyanate, 3-isopropenyl-α,α-dimethylbenzyl isocyanate and combinations thereof;
(iii10) alkoxysilyl functional ethylenically unsaturated compounds, preferably selected from allyl trimethoxysilane, allyl triethoxysilane, vinyl trimethoxysilane, vinyl triethoxy silane, 3-butenyltriethoxysilane, 3-(trimethoxysilyl)propyl (meth)acrylate, 5-hexenyltriethoxysilane, styrylethyltrimethoxysilane, trimethoxy(7-octen-1-yl)silane, 11-allyloxyundecyltrimethoxysilane, allylphenylpropyltriethoxysilane, [(5-bicyclo[2.2.1]hept-2-enyl)ethyl]trimethoxysilane, (5-bicyclo[2.2.1]hept-2-enyl)triethoxysilane, n-allyl-aza-2,2-dimethoxysilacyclopentane norbornenyltriethoxysilane, [2-(3-cyclohexenyl)ethyl]triethoxysilane and combinations thereof;
(iii11) alkoxy functional ethylenically unsaturated compounds, preferably selected from 2-methoxy ethyl (meth)acrylate, 2-ethoxy ethyl (meth)acrylate, methyl-3-methoxy(meth)acrylate and combinations thereof;
(iii12) dioxolanone functional ethylenically unsaturated compounds, preferably selected from glycerol carbonate (meth)acrylate, 4-vinyl-1,3-dioxolan-2-one and combinations thereof;
(iii13) halide functional ethylenically unsaturated compounds, preferably selected from vinyl chloride, allyl chloride, 2-chloro-1,3-butadiene, 2-chloroethyl acrylate, 3-chloro-2-hydroxypropyl methacrylate, methyl 2-(chloromethyl) (meth)acrylate, 2,3-dichloropropyl (meth)acrylate 2,3-dibromopropyl (meth)acrylate and combinations thereof;
(iii14) thiol functional ethylenically unsaturated compounds, preferably selected from allyl mercaptan, N-acryloyl-cysteamine and combinations thereof;
(iii15) hydroxylamine functional ethylenically unsaturated compounds, preferably selected from acrylohydroxamic acid;
(iii16) oxazolino functional ethylenically unsaturated compounds, preferably selected from oxazoline substituted acrylic ester;
(iii17) aziridino functional ethylenically unsaturated compounds, preferably selected from 2-(aziridine-1-yl)ethyl acrylate;
(iii18) imino functional ethylenically unsaturated compounds, preferably selected from 2-[(2-methylprop-2-enoyl)oxy]ethyl (3E)-3-(alkylimino)butanoate;
(iii19) carbodiimino functional ethylenically unsaturated compounds, preferably selected from N-α,α′-dimethyl isopropenyl benzyl-N′-cyclohexyl carbodiimide, N-α,α′-dimethyl isopropenyl benzyl-N′-butyl carbodiimide and combinations thereof;
(iii20) glycol functional ethylenically unsaturated compounds, preferably selected from ethylene glycol methyl ether (meth)acrylate, ethylene glycol phenyl ether (meth)acrylate, di(ethylene glycol) methyl ether (meth)acrylate, tri(ethylene glycol) methyl ether (meth)acrylate, poly(ethylene glycol) methyl ether (meth)acrylate, poly(ethylene glycol) phenyl ether acrylate, poly(ethylene glycol) (meth)acrylate, poly(propylene glycol) (meth)acrylate poly(ethylene glycol)-block-poly(propylene glycol)-block-poly(ethylene glycol) (meth)acrylate, polyglycol partial ester monomer and combinations thereof;
(iii21) hydrazido functional ethylenically unsaturated compounds, preferably selected from 2-propenoic acid hydrazide or (meth)acryloyl hydrazide and combinations thereof;
(iii22) aldehyde functional ethylenically unsaturated compounds, preferably selected from (meth)acrolein, 2-ethylacrolein, 3-methyl-2-butenal, tiglic aldehyde, crotonaldehyde, 3-methylcrotonaldehyde, 2-pentenal, 2-methyl-2-pentenal, 4-pentenal, 2,2-dimethyl-4-pentenal, 2,4-heptadienal and combinations thereof;
(iii23) ketone functional ethylenically unsaturated compounds, preferably selected from 1-penten-3-one, 3-buten-2-one, 4-methoxy-3-buten-2-one, 3-penten-2-one, 2-cyclopenten-1-one, 2-cyclohexen-1-one, and combinations thereof;
and combinations thereof;
(iv) the vinyl aromatic monomers may be selected from styrene, alpha-methyl styrene and combinations thereof;
(v) alkyl esters of ethylenically unsaturated acids may be selected from methyl (meth)acrylate, ethyl (meth)acrylate, propyl (meth)acrylate, butyl (meth)acrylate, 2-ethylhexyl (meth)acrylate, and combinations thereof;
and combinations thereof.

It is envisaged that:
the functional groups (A) of the latex polymer (a) may be selected from groups having a carbon-carbon double bond and the functional groups of the silane compound (b) may be selected from groups having carbon-carbon double bonds, (meth)acryloxy, and thiol;
the functional groups (A) of the latex polymer (a) may be selected from carboxylic acid functional groups and the functional groups of the silane compound (b) may be selected from epoxy, glycidyl, thiol, hydroxy, primary or secondary amino, isocyanato, oxazolino, aziridino, imino, carbodiimido, glycol groups, ester groups, and acetoxy;
the functional groups (A) of the latex polymer (a) may be selected from hydroxy and the functional groups of the silane compound (b) may be selected from carboxylic acid functional groups, isocyanato, primary or secondary amino, aldehyde, boronic acid and ester groups;
the functional groups (A) of the latex polymer (a) may be selected from epoxy and the functional groups of the silane compound (b) may be selected from carboxylic acid functional groups, hydroxy and ester groups;
the functional groups (A) of the latex polymer (a) may be selected from glycidyl and the functional groups of the silane compound (b) may be selected from carboxylic acid functional groups, hydroxy and ester groups;
the functional groups (A) of the latex polymer (a) may be selected from acetoacetoxy and the functional groups of the silane compound (b) may be selected from groups having carbon-carbon double bonds, (meth)acryloxy, isocyanato, aldehyde, hydrazine, hydrazide, and primary or secondary amino;
the functional groups (A) of the latex polymer (a) may be selected from primary or secondary amino and the functional groups of the silane compound (b) may be selected from carboxylic acid functional groups, epoxy, glycidyl, ester groups and dioxolanone groups;
the functional groups (A) of the latex polymer (a) may be selected from acetoxy and the functional groups of the silane compound (b) may be selected from hydrazido and primary or secondary amino;
the functional groups (A) of the latex polymer (a) may be selected from isocyanato and the functional groups of the silane compound (b) may be selected from carboxylic acid functional groups. hydroxy, primary or secondary amino and thiol;
the functional groups (A) of the latex polymer (a) may be selected from alkoxysilyl and the functional groups of the silane compound (b) may be selected hydroxy and alkoxysilyl;
the functional groups (A) of the latex polymer (a) may be selected from alkoxy and the functional groups of the silane compound (b) may be selected from ester groups;
the functional groups (A) of the latex polymer (a) may be selected from ester groups and the functional groups of the silane compound (b) may be selected from hydroxy, carboxylic acid groups and ester groups;
the functional groups (A) of the latex polymer (a) may be selected from dioxolanone groups and the functional groups of the silane compound (b) may be selected from primary or secondary amino;
the functional groups (A) of the latex polymer (a) may be selected from halide functional groups and the functional groups of the silane compound (b) may be selected from carboxylic acids;
the functional groups (A) of the latex polymer (a) may be selected from thiol functional groups and the functional groups of the silane compound (b) may be selected from carbon-carbon double bond, (meth)acryloxy, carboxylic acid functional groups, or isocyanato;
the functional groups (A) of the latex polymer (a) may be selected from hydroxylamine and the functional groups of the silane compound (b) may be selected from aldehyde;
the functional groups (A) of the latex polymer (a) may be selected from oxazolino and the functional groups of the silane compound (b) may be selected from carboxylic acid;
the functional groups (A) of the latex polymer (a) may be selected from aziridino and the functional groups of the silane compound (b) may be selected from carboxylic acid or hydroxy;
the functional groups (A) of the latex polymer (a) may be selected from imino and the functional groups of the silane compound (b) may be selected from carboxylic acid;
the functional groups (A) of the latex polymer (a) may be selected from carbodiimino and the functional groups of the silane compound (b) may be selected from carboxylic acid;
the functional groups (A) of the latex polymer (a) ma be selected from glycol groups and the functional groups of the silane compound (b) may be selected from carboxylic acid functional groups;
the functional groups (A) of the latex polymer (a) may be selected from hydrazido and the functional groups of the silane compound (b) may be selected from aldehyde;
the functional groups (A) of the latex polymer (a) may be selected from aldehyde and the functional groups of the silane compound (b) may be selected from hydroxy, acetoacetoxy, hydroxylamine, or hydrazido; or
the functional groups (A) of the latex polymer (a) may be selected from ketone and the functional groups of the silane compound (b) may be selected from hydroxy.

A further aspect of the invention relates to a method for preparing a polymer latex composition comprising:
(i) polymerizing in an emulsion polymerization process a monomer composition comprising ethylenically unsaturated monomers for latex polymer (a) comprising at least one monomer resulting after polymerization in a functional group (A) to obtain a latex comprising particles of latex polymer (a) comprising functional groups (A); and
(ii) adding a silane compound (b) selected from the compounds of Formula I, II, oligomers thereof or combinations of any of the foregoing:

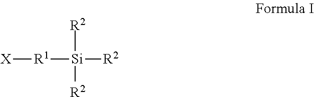

wherein
X is a functional group capable to form a bond with the functional group (A) of the latex polymer (a);
R¹ is a linking group between the functional group X and the silicon atom or R¹ is a bond;
R² independently is a hydrolysable group or a non-hydrolysable group;
wherein at least one of R² is a hydrolysable group and at least one of R² is a non-hydrolysable group;

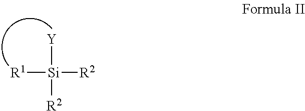

wherein
Y is O, S, NH or NR³; wherein R³ is a linear or branched, substituted or unsubstituted alkyl or alkenyl;
R¹ is a linking group between the functional group Y and the silicon atom;
R² independently is a hydrolysable group or a non-hydrolysable group;
wherein at least one of R² is a non-hydrolysable group; and
(iii) optionally adding a silane compound (c) different to silane compound (b), wherein silane compound (c) is selected from the compounds of Formula III, IV, oligomers thereof or combinations of any of the foregoing:

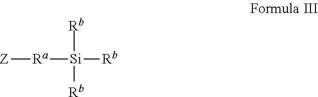

wherein
Z is a functional group capable to form a bond with the functional group (A) of the latex polymer (a);
R^{a} is a linking group between the functional group Z and the silicon atom or R^{a} is a bond;
R^{b} is a hydrolysable group;

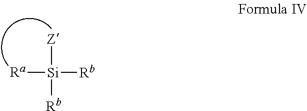

wherein
Z′ is O, S, NH or NR³; wherein R³ is a linear or branched, substituted or unsubstituted alkyl or alkenyl;
R^{a} is a linking group between the functional group Z′ and the silicon atom;
R^{b} is a hydrolysable group.

The monomer composition to obtain the particle of a latex polymer (a); functional groups (A) of the polymer latex (a); functional groups (X) of the silane compound (b); functional group (Z) of the silane compound (c); the hydrolysable groups R² and R^{b}; the non-hydrolysable group R², the linking groups R¹ and R^{a}; the amounts of the silane compounds (b) and/or (c); and the weight ratios of the silane compounds (b) and (c) may be as described above.

According to a further aspect, the invention relates to use of the polymer latex composition as described above or prepared by the method as described above for the production of dip-molded articles, an elastomeric film, a self-supporting elastomeric film or article or for coating or impregnating a substrate, preferably a textile substrate.

In addition, according to a further aspect, the invention relates to a compounded polymer latex composition suitable for the production of dip-molded articles comprising the polymer latex composition as described above or prepared by the method as described above and optionally adjuvants selected from sulfur vulcanization agents, accelerators for vulcanization, free-radical initiators, pigments and combinations thereof, preferably being free of sulfur vulcanization agents and accelerators for sulfur vulcanization and optionally comprising polyvalent cations and/or silica-based fillers.

Another aspect of the invention relates to a method for making dip-molded articles by
(a) providing a compounded latex composition as described above;
(b) immersing a mold having the desired shape of the final article in a coagulant bath comprising a solution of a metal salt;
(c) removing the mold from the coagulant bath and optionally drying the mold;
(d) immersing the mold as treated in step b) and c) in the compounded latex composition of step a);
(e) coagulating a latex film on the surface of the mold;
(f) removing the latex-coated mold from the compounded latex composition and optionally immersing the latex-coated mold in a water bath;
(g) optionally drying the latex-coated mold;
(h) heat treating the latex-coated mold obtained from step e) or f) at a temperature of 40° C. to 180° C.; and/or exposing the latex-coated mold obtained from step e) or f) to UV radiation;
(i) removing the latex article from the mold.

Furthermore, according to another aspect the invention relates to a method for the production of a continuous elastomeric film comprising:
(A) providing a polymer latex composition as defined or prepared as described above;
(B) forming from the aqueous polymer latex composition a continuous polymer film;
(C) optionally drying the continuous polymer film obtained in step B);
(D) heat treating the continuous polymer film obtained in step B) or C) at a temperature of 40° C. to 180° C. preferably for 20 min or less to form a continuous elastomeric film; and/or UV treating, and
(E) optionally rolling the continuous elastomeric film obtained in step D) into a roll.

Another aspect of the invention relates to a process for making an elastomeric article by
aligning two separate continuous elastomeric films obtained as described above;
cutting the aligned continuous elastomeric films into a preselected shape to obtain two superposed layers of the elastomeric films in the preselected shape; and
joining together the superposed layers of elastomeric film at least a preselected part of the periphery of the superposed layers to form an elastomeric article.

The joining together may be performed by using thermal means, preferably selected from heat sealing and welding or by gluing.

The cutting may be performed by a heatable template cutting device or laser cutter, providing the preselected shape and the cutting device may be heated in the sections that contact the elastomeric films where the films are joined together, thereby simultaneously cutting the elastomeric films into the preselected shape and heat sealing the preselected parts of the periphery of the superposed elastomeric films.

The present invention further relates to a method for repairing or reforming an elastomeric film or an article comprising said elastomeric film by
a) providing a film or article comprising an elastomeric film or films, having at least two surfaces to be reconnected,
b) re-joining the at least two surfaces of the elastomeric film(s), and heating or annealing the elastomeric film(s) while maintaining intimate contact of the rejoined surfaces of the damaged film at a temperature of 40 to 200° C., preferably 60 to 175° C., more preferably 95 to 135° C., wherein
c) the elastomeric film is made from a polymer latex composition as defined or prepared as described above.

Moreover, another aspect of the invention relates to an article made by using the polymer latex composition as defined or prepared as described above.

The article may be selected from surgical gloves, examination gloves, industrial gloves, household gloves, single-use gloves, textile supported gloves, catheters, elastomeric sleeves, condoms, balloons, tubing, dental dam, apron and pre-formed gasket.

### DETAILED DESCRIPTION OF THE INVENTION

The present invention relates to a polymer latex composition comprising:
(a) particles of a latex polymer obtained by free-radical emulsion polymerization of a composition comprising ethylenically unsaturated monomers, the latex polymer comprising a functional group (A); and (b) a silane compound selected from the compounds of Formula I, II, oligomers thereof or combinations of any of the foregoing:

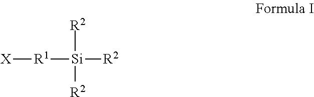

wherein X is a functional group capable to form a bond with the functional group (A) of the latex polymer (a); R¹ is a linking group between the functional group X and the silicon atom or R¹ is a bond; R² independently is a hydrolysable group or a non-hydrolysable group; wherein at least one of R² is a hydrolysable group and at least one of R² is a non-hydrolysable group;

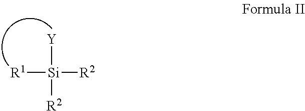

wherein Y is O, S, NH or NR³; wherein R³ is a linear or branched, substituted or unsubstituted alkyl or alkenyl; R¹ is a linking group between the functional group Y and the silicon atom; R² independently is a hydrolysable group or a non-hydrolysable group; wherein at least one of R² is a non-hydrolysable group. The polymer latex composition of the present invention is suitable for the preparation of elastomeric films.

The Si—Y bond of Formula II may be hydrolysable forming a Si—OH group and a Y—H group. When formed, the Y—H group is a functional group capable to form a bond with the functional group (A) of the latex polymer (a).

### Latex Polymer (a) Comprising a Functional Group (A)

The latex polymer (a) to be used according to the present invention can be prepared by any suitable free-radical emulsion polymerization process known in the art. Suitable process parameters are those that will be discussed below.

The unsaturated monomers to be used for the preparation of the latex polymer (a) and their relative amounts are not particularly critical as long as the monomer mixture comprises at least one ethylenically unsaturated monomer that provides for a functional group (A) on the latex polymer (a). Monomer compositions comprising conjugated dienes and ethylenically unsaturated nitrile compounds are particularly useful, e.g., for dip-molding applications.

Suitable functional groups (A) of the particles of the latex polymer (a) may be selected from the group consisting of carbon-carbon double bond, carboxylic acid, hydroxy, epoxy, glycidyl, acetoacetoxy, primary or secondary amino, acetoxy, isocyanato, alkoxysilyl, alkoxy, dioxolanone, halide functional group, thiol, hydroxylamine, oxazolino, aziridino, imino, carbodiimido, glycol, ester, hydrazido, aldehyde, ketone, and combinations thereof.

Preferably the functional groups (A) of the particles of the latex polymer (a) is selected from the group consisting of carbon-carbon double bond, carboxylic acid, halide functional group, epoxy, glycidyl, thiol, hydroxy, primary or secondary amino, isocyanato, and combinations thereof; more preferably from the group consisting of carboxylic acid.

According to the present invention, the monomer composition to obtain the particles of a latex polymer (a) may comprise:
(i) 15 to 99 wt.-% of conjugated dienes;
(ii) 1 to 80 wt.-% of monomers selected from ethylenically unsaturated nitrile compounds;
(iii) 0 to 10 wt.-% of an ethylenically unsaturated compound different from (i) and (ii) comprising a functional group (A);
(iv) 0 to 80 wt.-% of vinyl aromatic monomers; and
(v) 0 to 65 wt.-% of alkyl esters of ethylenically unsaturated acids;
the weight percentages being based on the total weight of the ethylenically unsaturated monomer monomers in the monomer composition.

Conjugated diene monomers suitable for the preparation of latex polymer (a) according to the present invention may include conjugated diene monomers selected from 1,3-butadiene, isoprene, 2,3-dimethyl-1,3-butadiene, 2,3-dimethyl-1,3-butadiene, 2-chloro-1,3-butadiene, 1,3-pentadiene, 1,3-hexadiene, 2,4-hexadiene, 1,3-octadiene, 2-methyl-1,3-pentadiene, 2,3-dimethyl-1,3-pentadiene, 3,4-dimethyl-1,3-hexadiene, 2,3-diethyl-1,3-butadiene, 4,5-diethyl-1,3-octadiene, 3-butyl-1,3-octadiene, 3,7-dimethyl-1,3,6-octatriene, 2-methyl-6-methylene-1,7-octadiene, 7-methyl-3-methylene-1,6-octadiene, 1,3,7-octatriene, 2-ethyl-1,3-butadiene, 2-amyl-1,3-butadiene, 3,7-dimethyl-1,3,7-octatriene, 3,7-dimethyl-1,3,6-octatriene, 3,7,11-trimethyl-1,3,6,10-dodecatetraene, 7,11-dimethyl-3-methylene-1,6,10-dodecatriene, 2,6-dimethyl-2,4,6-octatriene, 2-phenyl-1,3-butadiene, 2-methyl-3-isopropyl-1,3-butadiene, 1,3-cyclohexadiene and combinations thereof, preferably 1,3-butadiene, isoprene, 2,3-dimethyl-1,3-butadiene, 2-ethyl-1,3-butadiene, 1,3-pentadiene, 3,7,11-trimethyl-1,3,6,10-dodecatetraene, 7,11-dimethyl-3-methylene-1,6,10-dodecatriene, 7-methyl-3-methylene-1,6-octadiene, and combinations thereof. 1,3-Butadiene, isoprene and combinations thereof are the more preferred conjugated dienes. 1,3-Butadiene is the most preferred conjugated diene.

Typically, the amount of conjugated diene monomer ranges from 15 to 99 wt.-%, preferably from 20 to 95 wt.-%, more preferably from 30 to 75 wt.-%, most preferably from 40 to 70 wt.-%, based on the total weight of ethylenically unsaturated monomers in the monomer composition. Thus, the conjugated diene may be present in amounts of at least 15 wt.-%, at least 20 wt.-%, at least 22 wt.-%, at least 24 wt.-%, at least 26 wt.-%, at least 28 wt.-%, at least 30 wt.-%, at least 32 wt.-%, at least 34 wt.-%, at least 36 wt.-%, at least 38 wt.-%, or at least 40 wt.-%, based on the total weight of the ethylenically unsaturated monomers in the monomer composition. Accordingly, the conjugated diene monomers can be used in amounts of up to 99 wt.-%, up to 95 wt.-%, up to 90 wt.-%, up to 85 wt.-%, up to 80 wt.-%, up to 78 wt.-%, up to 76 wt.-%, up to 74 wt.-%, up to 72 wt.-%, up to 70 wt.-%, up to 68 wt.-%, up to 66 wt.-%, up to 64 wt.-%, up to 62 wt.-%, up to 60 wt.-%, up to 58 wt.-%, or up to 56 wt.-%, based on the total weight of the ethylenically unsaturated monomers in the monomer composition. A person skilled in the art will appreciate that any range between any of the explicitly disclosed lower and upper limit is herein disclosed.

Ethylenically unsaturated nitrile monomers which can be used in the present invention may include polymerizable unsaturated aliphatic nitrile monomers which preferably contain from 2 to 4 carbon atoms in a linear or branched arrangement, which may be substituted either by acetyl or additional nitrile groups. The ethylenically unsaturated nitrile compounds for the preparation of latex polymer (a) according to the present invention may be selected from (meth)acrylonitrile, alpha-cyanoethyl acrylonitrile, fumaronitrile, alpha-chloronitrile and combinations thereof, with acrylonitrile being most preferred.

These nitrile monomers can be included in amounts of from 1 to 80 wt.-%, preferably from 10 to 70 wt.-%, or 1 to 60 wt.-%, and more preferred from 15 to 50 wt.-%, even more preferred from 20 to 50 wt.-%, most preferred from 23 to 43 wt.-%, based on the total weight of ethylenically unsaturated monomers in the monomer composition. Thus, the unsaturated nitrile may be present in amounts of at least 1 wt.-%, at least 5 wt.-%, at least 10 wt.-%, at least 12 wt.-%, at least 14 wt.-%, at least 16 wt.-%, at least 18 wt.-%, at least 20 wt.-%, at least 22 wt.-%, at least 24 wt.-%, at least 26 wt.-%, at least 28 wt.-%, at least 30 wt.-%, at least 32 wt.-%, at least 34 wt.-%, at least 36 wt.-%, at least 38 wt.-%, or at least 40 wt.-%, based on the total weight of the ethylenically unsaturated monomers in the monomer composition. Accordingly, the unsaturated nitrile monomers can be used in amounts of up to 80 wt.-%, up to 75 wt.-%, up to 73 wt.-%, up to 70 wt.-%, up to 68 wt.-%, up to 66 wt.-%, up to 64 wt.-%, up to 62 wt.-%, up to 60 wt.-%, up to 58 wt.-%, up to 56 wt.-%, up to 54 wt.-%, up to 52 wt.-%, up to 50 wt.-%, up to 48 wt.-%, up to 46 wt.-%, or up to 44 wt.-%, based on the total weight of the ethylenically unsaturated monomers in the monomer composition. A person skilled in the art will appreciate that any range between any of the explicitly disclosed lower and upper limit is herein disclosed.

The ethylenically unsaturated compounds different from (i) and (ii) comprising a functional group (A) suitable for the preparation of latex polymer (a) according to the present invention may be selected from:
(iii1) ethylenically unsaturated compounds having at least two different ethylenically unsaturated groups;
(iii2) ethylenically unsaturated acids and salts thereof;
(iii3) hydroxy functional ethylenically unsaturated compounds;
(iii4) epoxy functional ethylenically unsaturated compounds;
(iii5) glycidyl functional ethylenically unsaturated compounds;
(iii6) acetoacetoxy functional ethylenically unsaturated compounds;
(iii7) ethylenically unsaturated compounds bearing a primary or secondary amino group;
(iii8) acetoxy functional ethylenically unsaturated compounds;
(iii9) isocyanato functional ethylenically unsaturated compounds;
(iii10) alkoxysilyl functional ethylenically unsaturated compounds;
(iii11) alkoxy functional ethylenically unsaturated compounds;
(iii12) dioxolanone functional ethylenically unsaturated compounds;
(iii13) halide functional ethylenically unsaturated compounds;
(iii14) thiol functional ethylenically unsaturated compounds;
(iii15) hydroxylamine functional ethylenically unsaturated compounds;
(iii16) oxazolino functional ethylenically unsaturated compounds;
(iii17) aziridino functional ethylenically unsaturated compounds;
(iii18) imino functional ethylenically unsaturated compounds;
(iii19) carbodiimino functional ethylenically unsaturated compounds;
(iii20) glycol functional ethylenically unsaturated compounds;
(iii21) hydrazido functional ethylenically unsaturated compounds;
(iii22) aldehyde functional ethylenically unsaturated compounds;
(iii23) ketone functional ethylenically unsaturated compounds;
and combinations thereof.

Suitable ethylenically unsaturated compounds having at least two different ethylenically unsaturated groups (iii1) may be selected from allyl(meth)acrylate, vinyl(meth)acrylate, and combinations thereof.

Suitable ethylenically unsaturated acids and salts thereof (iii2) may be selected from ethylenically unsaturated carboxylic acid monomers and anhydrides thereof, ethylenically unsaturated sulfonic acid monomers, and ethylenically unsaturated phosphorous-containing acid monomers. The ethylenically unsaturated carboxylic acid monomers and anhydrides thereof suitable for use in the present invention include monocarboxylic acid monomers such as (meth)acrylic acid, crotonic acid and vinyl acetic acid; dicarboxylic acid monomers such as fumaric acid, itaconic acid, maleic acid and maleic anhydride; monoesters of dicarboxylic acid; carboxy alkyl esters of ethylenically unsaturated acids such as 2-carboxy ethyl (meth)acrylate, polycarboxylic acid and anhydride thereof and polycarboxylic acid partial ester monomer. Examples of ethylenically unsaturated sulfonic acid monomers include vinyl sulfonic acid, sodium 4-vinylbenzenesulfonate, 2-methyl-2-propene-1-sulfonic acid, 4-styrenesulfonic acid, 3-allyloxy-2-hydroxy-1-propanesulfonic acid, 2-acrylamido-2-methyl-1-propanesulfonic acid and the salts thereof. Examples of ethylenically unsaturated phosphorus-containing acid monomers include vinylphosphonic acid, dimethyl vinylphosphonate, diethyl vinylphosphonate, diethyl allylphosphonate, allylphosphonic acid and the salts thereof.

Preferably, the ethylenically unsaturated acids and salts thereof (iii2) are selected from (meth)acrylic acid, crotonic acid, itaconic acid, maleic acid, fumaric acid, ethylenically unsaturated sulfonic acids, ethylenically unsaturated phosphorous containing acids, polycarboxylic acid anhydride, polycarboxylic acid partial ester monomer, carboxylic alkyl esters of ethylenically unsaturated acids and combinations thereof.

Suitable hydroxy functional ethylenically unsaturated compounds (iii3) may be selected from allyl alcohol, vinyl alcohol, N-methylolacrylamide, 1-penten-3-ol, hydroxyalkyl esters of ethylenically unsaturated acids and combinations thereof. Hydroxyalkyl esters of ethylenically unsaturated acids include hydroxy alkyl(meth)acrylate monomers, such as hydroxyethyl (meth)acrylate, hydroxypropyl (meth)acrylate, hydroxybutyl (meth)acrylate, glycerol (meth)acrylate, 2-hydroxypropyl maleate, and glycerol undecenoate.

Suitable epoxy functional ethylenically unsaturated compounds (iii4) may be selected from vinyl cyclohexene oxide, limonene oxide, (3′,4′-epoxyheptyl)-2-ethyl (meth)acrylate, (6′,7′-epoxyheptyl)(meth)acrylate, allyl-3,4-epoxyheptylether, 6,7-epoxyheptylallylether, vinyl-3,4-epoxyheptylether, 3,4-epoxyheptylvinylether, 6,7-epoxyheptylvinylether, 3-vinyl cyclohexene oxide, 2-(3,4-epoxycyclohexyl)methyl (meth)acrylate, 3,4-epoxy-1-butene, 1,2-epoxy-5-hexene, 4-vinyl-1-cyclohexene 1,2-epoxide, 2-methyl-2-vinyloxirane, 3,4-epoxy-1-cyclohexene and combinations thereof.

Suitable glycidyl functional ethylenically unsaturated compounds (iii5) may be selected from glycidyl (meth)acrylate, allyl glycidylether, vinyl glycidylether, 2-ethylglycidyl (meth)acrylate, 2-(n-propyl)glycidyl (meth)acrylate, 2-(n-butyl)glycidyl (meth)acrylate, o-vinylbenzylglycidylether, m-vinylbenzylglycidylether, p-vinylbenzylglycidylether, alpha-methyl glycidyl methacrylate, glycidyl propargyl ether and combinations thereof.

Suitable acetoacetoxy functional ethylenically unsaturated compounds (iii6) may be selected from acetoacetoxyethyl (meth)acrylate, acetoacetoxypropyl (meth)acrylate, allyl acetoacetate, acetoacetoxybutyl (meth)acrylate, 2,3-di(acetoacetoxy)propyl (meth)acrylate, acetoacetoxy(methyl)ethyl (meth)acrylate, acetoacetamido-ethyl(meth)acrylate, 3-(methacryloyloxy)-2,2-dimethylpropyl 3-oxobutanoate, 3-(methacryloyloxy)-2,2,4,4-tetramethylcyclobutyl 3-oxobutanoate, 3-(methacryloyloxy)-2,2,4-trimethylpentyl 3-oxobutanoate, 1-(methacryloyloxy)-2,2,4-trimethylpentan-3-yl 3-oxobutanoate, (4-(methacryloyloxymethyl)cyclohexyl)methyl 3-oxobutanoate and combinations thereof.

Ethylenically unsaturated compounds bearing a primary or secondary amino group (iii7) suitable for the preparation of latex polymer (a) according to the present invention may be selected from (meth)acrylamide, 2-amino ethyl (meth)acrylate hydrochloride, 2-amino ethyl (meth) acrylamide hydrochloride, N-ethyl (meth)acrylamide, N-(3-amino propyl) (meth)acrylamide hydrochloride, N-hydroxyethyl (meth)acrylamide, N-3-(dimethylamino) propyl (meth)acrylamide, [3-(methacryloylamino)propyl]trimethylammonium, N-[tris(hydroxymethyl) methyl](meth)acrylamide, N-phenylacrylamide, alkylacrylamide, methacrylamide poly(ethylene glycol) amine hydrochloride and combinations thereof.

Suitable acetoxy functional ethylenically unsaturated compounds (iii8) may be selected from 1-acetoxy-1,3-butadiene, diacetoneacrylamide and combinations thereof.

Suitable isocyanato functional ethylenically unsaturated compounds (iii9) may be selected from 2-isocyanatoethyl(meth)acrylate, allyl isocyanate, vinyl isocyanate, 3-isopropenyl-α,α-dimethylbenzyl isocyanate and combinations thereof.

Suitable alkoxysilyl functional ethylenically unsaturated compounds (iii10) may be selected from allyl trimethoxysilane, allyl triethoxysilane, vinyl trimethoxysilane, vinyl triethoxy silane, 3-butenyltriethoxysilane, 3-(trimethoxysilyl)propyl (meth)acrylate, 5-hexenyltriethoxysilane, styrylethyltrimethoxysilane, trimethoxy(7-octen-1-yl)silane, 11-allyloxyundecyltrimethoxysilane, allylphenylpropyltriethoxysilane, [(5-bicyclo[2.2.1]hept-2-enyl)ethyl]trimethoxysilane, (5-bicyclo[2.2.1]hept-2-enyl)triethoxysilane, n-allyl-aza-2,2-dimethoxysilacyclopentane norbornenyltriethoxysilane, [2-(3-cyclohexenyl)ethyl]triethoxysilane and combinations thereof.

Suitable alkoxy functional ethylenically unsaturated compounds (iii11) may be selected from N-methoxymethyl-(meth)acrylamide, N-n-butoxy-methyl-(meth)acrylamide, N-iso-butoxy-methyl-(meth)acrylamide, 2-methoxy ethyl (meth)acrylate, 2-ethoxy ethyl (meth)acrylate, 2-butoxy ethyl (meth)acrylate, methoxy ethoxy ethyl acrylate, methyl-3-methoxy(meth)acrylate, and combinations thereof. Preferred alkoxy functional ethylenically unsaturated compounds are 2-methoxy ethyl (meth)acrylate, 2-ethoxy ethyl (meth)acrylate, methyl-3-methoxy(meth)acrylate and combinations thereof.

Suitable dioxolanone functional ethylenically unsaturated compounds (iii12) may be selected from glycerol carbonate (meth)acrylate, 4-vinyl-1,3-dioxolan-2-one and combinations thereof

Suitable halide functional ethylenically unsaturated compounds (iii13) may be selected from vinyl chloride, allyl chloride, 2-chloro-1,3-butadiene, 2-chloroethyl acrylate, 3-chloro-2-hydroxypropyl methacrylate, methyl 2-(chloromethyl) (meth)acrylate, 2,3-dichloropropyl (meth)acrylate, 2,3-dibromopropyl (meth)acrylate and combinations thereof.

Suitable thiol functional ethylenically unsaturated compounds (iii14) may be selected from allyl mercaptan, N-acryloyl-cysteamine and combinations thereof.

Suitable hydroxylamine functional ethylenically unsaturated compounds (iii15) may be selected from acrylohydroxamic acid.

Suitable oxazolino functional ethylenically unsaturated compounds (iii16) may be selected from oxazoline substituted acrylic ester. Suitable oxazoline substituted acrylic esters and the synthesis thereof are described in U.S. Pat. No. 6,063,885.

Suitable aziridino functional ethylenically unsaturated compounds (iii17) may be selected from 2-(aziridine-1-yl)ethyl acrylate.

Suitable imino functional ethylenically unsaturated compounds (iii18) may be selected from 2-[(2-methylprop-2-enoyl)oxy]ethyl (3E)-3-(alkylimino)butanoate. Imino functional ethylenically unsaturated compounds (iii18) may be prepared by reaction of a primary or secondary amine with acetoacetoxyethyl (meth)acrylate as described in Esser, R. J., Devona, J. E., Setzke, D. E. and Wagemans L. Prog. Org. Coat., 1999, 36 (1-2) 45-52 & Yu, Z., Alesso, S., Pears, D., Worthington, P. A., Luke, R. W. A., Bradley, M., Tetrahedron Lett., 2000, 41 (46) 8963-8967.

Suitable carbodiimino functional ethylenically unsaturated compounds (iii19) may be selected from N-α,α′-dimethyl isopropenyl benzyl-N′-cyclohexyl carbodiimide, N-α,α′-dimethyl isopropenyl benzyl-N′-butyl carbodiimide and combinations thereof. The synthesis of said carbodiimino functional ethylenically unsaturated compound is described in Pham, H. H. and Winnik, M. A., J Polym Sci A Polym Chem, 2000, 38, 855-869.

Suitable glycol functional ethylenically unsaturated compounds (iii20) may be selected from ethylene glycol methyl ether (meth)acrylate, ethylene glycol phenyl ether (meth)acrylate, di(ethylene glycol) methyl ether (meth)acrylate, tri(ethylene glycol) methyl ether (meth)acrylate, poly(ethylene glycol) methyl ether (meth)acrylate, poly(ethylene glycol) phenyl ether acrylate, poly(ethylene glycol) (meth)acrylate, poly(propylene glycol) (meth)acrylate poly(ethylene glycol)-block-poly(propylene glycol)-block-poly(ethylene glycol) (meth)acrylate, polyglycol partial ester monomer and combinations thereof.

Suitable hydrazido functional ethylenically unsaturated compounds (iii21) may be selected from 2-propenoic acid hydrazide, methacryloyl hydrazide and combinations thereof.

Suitable aldehyde functional ethylenically unsaturated compounds (iii22) may be selected from (meth)acrolein, 2-ethylacrolein, 3-methyl-2-butenal, tiglic aldehyde, crotonaldehyde, 3-methylcrotonaldehyde, 2-pentenal, 2-methyl-2-pentenal, 4-pentenal, 2,2-dimethyl-4-pentenal, 2,4-heptadienal and combinations thereof.

Suitable ketone functional ethylenically unsaturated compounds (iii23) may be selected from 1-penten-3-one, 3-buten-2-one, 4-methoxy-3-buten-2-one, 3-penten-2-one, 2-cyclopenten-1-one, 2-cyclohexen-1-one, and combinations thereof.

The compound (iii) may provide functional groups (A) besides the conjugated dienes (i) that may provide carbon-carbon double bonds as a functional group (A). The ethylenically unsaturated compound (iii) different from (i) and (ii) comprising a functional group (A) may be present in amounts of from 0 to 10 wt.-%, preferably from 0.05 to 10 wt.-%, particularly from 0.1 to 10 wt.-% or 0.5 to 7 wt.-%, more preferably from 0.7 to 8 wt.-%, even more preferred from 1.0 to 7 wt.-%, most preferred 2.0 to 7 wt.-%, based on the total weight of the ethylenically unsaturated monomers in the monomer composition. Thus, the ethylenically unsaturated compound (iii) may be present in amounts of at least 0.01 wt.-%, at least 0.05 wt.-%, at least 0.1 wt.-%, at least 0.3 wt.-%, at least 0.5 wt.-%, at least 0.7 wt.-%, at least 0.9 wt.-%, at least 1.0 wt.-%, at least 1.2 wt.-%, at least 1.4 wt.-%, at least 1.6 wt.-%, at least 1.8 wt.-%, at least 2.0 wt.-%, at least 2.5 wt.-%, or at least 3.0 wt.-%, based on the total weight of the ethylenically unsaturated monomers in the monomer composition. Likewise, the ethylenically unsaturated compound (iii) may be present in amounts of up to 10 wt.-%, up to 9.5 wt.-%, up to 9 wt.-%, up to 8.5 wt.-%, up to 8 wt.-%, up to 7.5 wt.-%, up to 7 wt.-%, up to 6.5 wt.-%, up to 6 wt.-%, up to 5.5 wt.-%, or up to 5 wt.-%, based on the total weight of ethylenically unsaturated monomers in the monomer composition. A person skilled in the art will appreciate that any range defined by an explicitly disclosed lower limit and an explicitly disclosed upper limit is disclosed herewith.

Suitable examples of vinyl-aromatic monomers (iv) may be selected from styrene, α-methylstyrene, vinyltoluene, o-methylstyrene, p-methylstyrene, p-tert-butylstyrene, 2,4-dimethylstyrene, 2-methylstyrene, 3-methylstyrene, 4-methylstyrene, 2-ethylstyrene, 3-ethylstyrene, 4-ethylstyrene, 2,4-diisopropylstyrene, 2,4-dimethylstyrene, 4-tert-butylstyrene, 5-tert-butyl-2-methylstyrene, vinylnaphthalene, vinyltoluene, vinylxylene, 2-vinylpyridine, 4-vinylpyridine, 1,1-diphenylethylenes, 1,2-diphenylethene and combinations thereof. Preferably, vinyl-aromatic monomers (iv) are selected from styrene, α-methylstyrene, and combinations thereof.

The vinyl-aromatic compounds (vi) can be used in a range of from 0 to 80 wt.-%, or 0 to 70 wt.-%, or 0 to 50 wt.-%, preferably from 0 to 40 wt.-% more preferred from 0 to 25 wt.-%, even more preferred from 0 to 15 wt.-%, and most preferred from 0 to 10 wt.-%, based on the total weight of ethylenically unsaturated monomers in the monomer composition. Thus, the vinyl-aromatic compound (iv) can be present in an amount of up to 80 wt.-%, up to 75 wt.-%, up to 60 wt.-%, up to 50 wt.-%, up to 40 wt.-%, up to 35 wt.-%, up to 30 wt.-%, up to 25 wt.-%, up to 20 wt.-%, up to 18 wt.-%, up to 16 wt.-%, up to 14 wt.-%, up to 12 wt.-%, up to 10 wt.-%, up to 8 wt.-%, up to 6 wt.-%, up to 4 wt.-%, up to 2 wt.-%, or up to 1 wt.-%, based on the total weight of ethylenically unsaturated monomers in the monomer composition. Vinyl-aromatic compounds (iv) may also be completely absent in the monomer composition to obtain the particles of a latex polymer (a).

Suitable examples of alkyl ester of ethylenically unsaturated acids (v) may be selected from n-alkyl esters, iso-alkyl esters or tert-alkyl esters of (meth)acrylic acid in which the alkyl group has from 1 to 20 carbon atoms, the reaction product of methacrylic acid with glycidyl ester of a neoacid such as versatic acid, neodecanoic acid or pivalic acid.

In general, the preferred alkyl esters of (meth)acrylic acids may be selected from C₁-C₁₀ alkyl (meth)acrylate, preferably C₁-C₈-alkyl (meth)acrylates. Examples of such (meth)acrylate monomers include n-butyl acrylate, secondary butyl acrylate, ethyl acrylate, hexyl acrylate, tert-butyl acrylate, 2-ethyl-hexyl acrylate, isooctyl acrylate, 4-methyl-2-pentyl acrylate, 2-methylbutyl acrylate, methyl methacrylate, tert-butyl methacrylate, n-butyl methacrylate, isobutyl methacrylate, ethyl methacrylate, isopropyl methacrylate, hexyl methacrylate, cyclohexyl methacrylate and cetyl methacrylate. Methyl (meth)acrylate, ethyl (meth)acrylate, propyl (meth)acrylate, butyl (meth)acrylate, 2-ethylhexyl (meth)acrylate and combinations thereof are preferred.

Typically, the alkyl esters of ethylenically unsaturated acids (v) can be present in an amount of up to 65 wt.-%, up to 60 wt.-%, up to 55 wt.-%, up to 50 wt.-%, up to 45 wt.-%, up to 40 wt.-%, up to 35 wt.-%, up to 30 wt.-%, up to 25 wt.-%, up to 20 wt.-%, up to 18 wt.-%, up to 16 wt.-%, up to 14 wt.-%, up to 12 wt.-%, up to 10 wt.-%, up to 8 wt.-%, up to 6 wt.-%, up to 4 wt.-%, up to 2 wt.-%, or up to 1 wt.-%, based on the total weight of ethylenically unsaturated monomers in the monomer composition.

According to the present invention, the monomer composition to obtain the particles of a latex polymer (a) may comprise:
(i) 30 to 75 wt.-% of conjugated dienes;
(ii) 15 to 50 wt.-% of monomers selected from ethylenically unsaturated nitrile compounds;
(iii) 0.1 to 10 wt.-% of an ethylenically unsaturated compound different from (i) and (ii) comprising a functional group (A);
(iv) 0 to 40 wt.-% of vinyl aromatic monomers; and
(v) 0 to 30 wt.-% of alkyl esters of ethylenically unsaturated acids;
the weight percentages being based on the total weight of the ethylenically unsaturated monomer monomers in the monomer composition.

Further, the mixture of ethylenically unsaturated monomers for latex polymer (a) may include additional ethylenically unsaturated monomers that are different from the above-defined monomers. These monomers may be selected from vinyl carboxylates (vi) and/or monomers having two identical ethylenically unsaturated groups (vii).

Vinyl carboxylate monomers (vi) which can be used according to the present invention include vinyl acetate, vinyl propionate, vinyl butyrate, vinyl benzoate, vinyl-2-ethylhexanoate, vinyl stearate, and the vinyl esters of versatic acid. The most preferred vinyl ester monomer for use in the present invention is vinyl acetate. Typically, the vinyl ester monomers can be present in an amount of up to 18 wt.-%, up to 16 wt.-%, up to 14 wt.-%, up to 12 wt.-%, up to 10 wt.-%, up to 8 wt.-%, up to 6 wt.-%, up to 4 wt.-%, up to 2 wt.-%, or up to 1 wt.-%, based on the total weight of ethylenically unsaturated monomers in the monomer mixture.

Furthermore, monomers having at least two identical ethylenically unsaturated groups (vii) can be present in the monomer mixture for the preparation of the polymer latex of the present invention in an amount of from 0 to 6.0 wt.-%, preferably 0.1 to 3.5 wt.-%, based on the total weight of ethylenically unsaturated monomers in the monomer mixture. Typically, these monomers can be present in an amount of up to 6 wt.-%, up to 4 wt.-%, up to 2 wt.-%, up to 1 wt.-%, based on the total weight of ethylenically unsaturated monomers in the monomer mixture. Suitable bifunctional monomers (vii) which are capable of providing internal crosslinking and branching in the polymer (herein known as multifunctional monomers) may be selected from divinyl benzene and diacrylates and di(meth)acrylates.

Examples are ethylene glycol di(meth)acrylate, hexanediol di(meth)acrylate, tripropylene glycol di(meth)acrylate, butanediol di(meth)acrylate, neopentyl glycol di(meth)acrylate, diethylene glycol di(meth)acrylate, triethylene glycol di(meth)acrylate, and dipropylene glycol di(meth)acrylate. The monomers having at least two ethylenically unsaturated groups (vii) are preferably selected from divinyl benzene, 1,2-ethyleneglycol di(meth)acrylate, 1,4-butanediol di(meth)acrylate and 1,6-hexanediol di(meth)acrylate, and combinations thereof.

According to the present invention, the amounts of the above-defined monomers for the preparation of latex polymer (a) may add up to 100 wt.-%.

### Method for the Preparation of the Polymer Latex (a) of the Present Invention:

The latex polymer (a) according to the present invention can be made by any emulsion polymerization process known to a person skilled in the art. Particularly suitable is the process as described in EP-A 792 891.

In the emulsion polymerization for preparing the latex polymer (a) of the present invention a seed latex may be employed. Any seed particles as known to the person skilled in the art can be used.

The seed latex particles are preferably present in an amount of 0.01 to 10, preferably 1 to 5 parts by weight, based on 100 parts by weight of total ethylenically unsaturated monomers in the monomer mixture. The lower limit of the amount of seed latex particles therefore can be 0.01, 0.05, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, or 2.5 parts by weight, based on 100 parts by weight of total ethylenically unsaturated monomers in the monomer mixture. The upper limit of the amount can be 10, 9, 8, 7, 6, 5.5, 5, 4.5, 4, 3.8, 3.6, 3.4, 3.3, 3.2, 3.1 or 3 parts by weight, based on 100 parts by weight of total ethylenically unsaturated monomers in the monomer mixture. A person skilled in the art will understand that any range formed by any of the explicitly disclosed lower limits and upper limits is explicitly encompassed in the present specification.

The process for the preparation of the above-described polymer latex can be performed at temperatures of from 0 to 130° C., preferably of from 0 to 100° C., particularly preferably of from 5 to 70° C., very particularly preferably of from 5 to 60° C., in the presence of no or one or more than one emulsifiers, no or one or more colloids and one or more than one initiators. The temperature includes all values and sub-values therebetween, especially including 5, 10, 15, 20, 25, 30, 35, 40, 45, 50, 55, 60, 65, 70, 75, 80, 85, 90, 95, 100, 105, 110, 115, 120 and 125° C.

Initiators which can be used when carrying out the present invention include water-soluble and/or oil-soluble initiators which are effective for the purposes of the polymerization. Representative initiators are well known in the technical area and include, for example: azo compounds (such as, for example, AIBN, AMBN and cyanovaleric acid) and inorganic peroxy compounds, such as hydrogen peroxide, sodium, potassium and ammonium peroxydisulfate, peroxycarbonates and peroxyborates, as well as organic peroxy compounds, such as alkyl hydroperoxides, dialkyl peroxides, acyl hydroperoxides, and diacyl peroxides, as well as esters, such as tertiary butyl perbenzoate and combinations of inorganic and organic initiators.

The initiator is used in a sufficient amount to initiate the polymerization reaction at a desired rate. In general, an amount of initiator of from 0.01 to 5 wt.-%, preferably of from 0.1 to 4 wt.-%, based on the total weight of monomers in the monomer mixture, is sufficient. The amount of initiator is most preferably of from 0.01 to 2 wt.-%, based on the total weight of monomers in the monomer mixture. The amount of initiator includes all values and sub-values therebetween, especially including 0.01, 0.1, 0.5, 1, 1.5, 2, 2.5, 3, 4 and 4.5 wt.-%, based on the total weight of monomers in the monomer mixture.

The above-mentioned inorganic and organic peroxy compounds may also be used alone or in combination with one or more suitable reducing agents, as is well known in the art. Examples of such reducing agents may include sulfur dioxide, alkali metal disulfites, alkali metal and ammonium hydrogen sulfites, thiosulfates, dithionites and formaldehyde sulfoxylates, as well as hydroxylamine hydrochloride, hydrazine sulfate, iron (II) sulfate, cuprous naphthenate, glucose, sulfonic acid compounds such as sodium methane sulfonate, amine compounds such as dimethylaniline and ascorbic acid. The quantity of the reducing agent is preferably 0.03 to 10 parts by weight per parts by weight of the polymerization initiator.

Surfactants or emulsifiers which are suitable for stabilizing the latex particles include those conventional surface-active agents for polymerization processes. The surfactant or surfactants can be added to the aqueous phase and/or the monomer phase. An effective amount of surfactant in a seed process is the amount which was chosen for supporting the stabilization of the particle as a colloid, the minimization of contact between the particles and the prevention of coagulation. In a non-seeded process, an effective amount of surfactant is the amount which was chosen for influencing the particle size.

Representative surfactants include saturated and ethylenically unsaturated sulfonic acids or salts thereof, including, for example, unsaturated hydrocarbonsulfonic acid, such as vinylsulfonic acid, allylsulfonic acid and methallylsulfonic acid, and salts thereof; aromatic hydrocarbon acids, such as, for example, p-styrenesulfonic acid, isopropenylbenzenesulfonic acid and vinyloxybenzenesulfonic acid and salts thereof; sulfoalkyl esters of (meth)acrylic acid, such as, for example, sulfoethyl methacrylate and sulfopropyl methacrylate and salts thereof, and 2-acrylamido-2-methylpropanesulfonic acid and salts thereof; alkylated diphenyl oxide disulfonates, sodium dodecylbenzenesulfonates and dihexyl esters of sodium sulfosuccinate, sodium alkyl esters of sulfonic acid, ethoxylated alkylphenols and ethoxylated alcohols; fatty alcohol (poly)ethersulfates.

The type and the amount of the surfactant is governed typically by the number of particles, their size and their composition. Typically, the surfactant is used in amounts of from 0 to 20 wt.-%, preferably from 0 to 10 wt.-%, more preferably from 0 to 5 wt.-%, based on the total weight of the monomers in the monomer mixture. The amount of surfactant includes all values and sub-values therebetween, especially including 0, 0.1, 0.5, 1, 2, 3, 4, 5, 6, 7, 8, 9, 10, 11, 12, 13, 14, 15, 16, 17, 18 and 19 wt.-%, based on the total weight of the monomer in the monomer mixture. The polymerization may be conducted without using surfactants.

Various protective colloids can also be used instead of or in addition to the surfactants described above. Suitable colloids include polyhydroxy compounds, such as partially acetylated polyvinyl alcohol, casein, hydroxyethyl starch, carboxymethylcellulose, hydroxyethylcellulose, hydroxypropylcellulose, polysaccharides, and degraded polysaccharides, polyethylene glycol and gum arabic. The preferred protective colloids are carboxymethylcellulose, hydroxyethylcellulose and hydroxypropylcellulose. In general, these protective colloids are used in contents of from 0 to 10 parts by weight, preferably from 0 to 5 parts by weight, more preferably from 0 to 2 parts by weight, based on the total weight of the monomers in the monomer mixture. The amount of protective colloids includes all values and sub-values therebetween, especially including 1, 2, 3, 4, 5, 6, 7, 8 and 9 wt.-%, based on the total weight of the monomers in the monomer mixture.

The person skilled in the art will appreciate the type and amounts of monomers bearing polar functional groups, surfactants and protective colloids that are to be selected to make the polymer latex according to the present invention suitable for dip-molding applications. Thus, it is preferred that the polymer latex composition of the present invention has a certain maximum electrolyte stability determined as critical coagulation concentration of less than 30 mmol/l CaCl₂, preferably less than 25 mmol/l, more preferred less than 20 mmol/l, most preferred less than 10 mmol/l (determined for a total solids content of the composition of 0.1% at pH 10 and 23° C.).

It is frequently advisable to perform the emulsion polymerization additionally in the presence of buffer substances and chelating agents. Suitable substances are, for example, alkali metal phosphates and pyrophosphates (buffer substances) and the alkali metal salts of ethylenediaminetetraacetic acid (EDTA) or hydroxyl-2-ethylenediaminetriacetic acid (HEEDTA) as chelating agents. The quantity of buffer substances and chelating agents is usually 0.001 to 1.0 wt.-%, based on the total weight of monomers in the monomer mixture.

Furthermore, it may be advantageous to use chain transfer agents (regulators) in emulsion polymerization. Typical agents are, for example, organic sulfur compounds, such as thioesters, 2-mercaptoethanol, 3-mercaptopropionic acid and C₁-C₁₂ alkyl mercaptans, n-dodecylmercaptan and t-dodecylmercaptan being preferred. The quantity of chain transfer agents, if present, is usually 0.05-3.0 wt.-%, preferably 0.2-2.0 wt.-%, based on the total weight of the monomers in the monomer mixture.

Furthermore, it can be beneficial to introduce partial neutralization to the polymerization process. A person skilled in the art will appreciate that by appropriate selection of this parameter the necessary control can be achieved.

Various other additives and ingredients can be added in order to prepare the latex composition of the present invention. Such additives include, for example: antifoams, wetting agents, thickeners, plasticizers, fillers, pigments, dispersants, optical brighteners, crosslinking agents, accelerators, antioxidants, biocides and metal chelating agents. Known antifoams include silicone oils and acetylene glycols. Customary known wetting agents include alkylphenol ethoxylates, alkali metal dialkylsulfosuccinates, acetylene glycols and alkali metal alkylsulfate. Typical thickeners include polyacrylates, polyacrylamides, xanthan gums, modified celluloses or particulate thickeners, such as silicas and clays. Typical plasticizers include mineral oil, liquid polybutenes, liquid polyacrylates and lanolin. Zinc oxide is a suitable crosslinking agent. Titanium dioxide (TiO₂), calcium carbonate and clay are the fillers typically used. Known accelerators and secondary accelerators include dithiocarbamates like zinc diethyl dithiocarbamate, zinc dibutyl dithiocarbamate, zinc dibenyl dithiocarbamate, zinc pentamethylene dithiocarbamate (ZPD), xanthates, thiurams like tetramethylthiuram monosulfide (TMTM), tetramethylthiuram disulfide (TMTD), tetraethylthiuram disulfide (TETD), dipentamethylenethiuram hexasulfide (DPTT), and amines, such as diphenylguanidine (DPG), di-o-tolylguanidine (DOTG), and o-tolylbiguanidine (OTBG).

### Silane Compound (b)

The polymer latex composition comprises a silane compound (b) selected from the compounds of Formula I, II, oligomers thereof or combinations of any of the foregoing.

As used herein, the term “oligomers thereof” refers to polysiloxane oligomers comprising at least two repeating units and formed by hydrolysis and condensation of the silane compound (b), i.e., selected from the Formula I, II, and combinations thereof. The polysiloxane oligomers may be prepared by hydrolyzing the silane compound (b) to form a silanol, and condensing the silanol by removing water. Hydrolyzing of the silane compound may be performed in the presence of water, such as 2 to 15 moles of water per mole of silane; and optionally in the presence of a hydrolysis catalyst to provide an intermediate containing a silanol. The hydrolysis may be performed at a temperature of from 10 to 100° C. Suitable examples of a hydrolysis catalyst include metal salts, alkyl ammonium salts, ion exchange resins, carboxylic acids, mineral acids or metal chelates, preferably carboxylic acids. The catalysts may be used in amounts of from 1 ppm to 1 wt.-%, based on the total weight of the silane compounds. It can further be advantageous to remove byproducts of the hydrolysis such as alcohols by distillation. The condensation of the silanol to from the oligomeric polysiloxane may be achieved by removing water such as by distillation. The distillation to remove water may be carried out at a temperature of from 10 to 100° C. and preferably at a pressure from 0.01 kPa to 200 kPa. The removal of water and condensation of the silanol typically requires from 1 to 200 hours, more specifically from 2 to 24 hours. The removal of water and condensation of the silanols can be assisted by sparging the reaction mixture with an inert gas, such as nitrogen. A suitable method for preparing such oligomers is described in more detail in US 2013/0158159 A1, specifically in paragraphs [0046] to [0072] and [0117] to [0146].

The silane compound (b) may be selected from Formula I, oligomers thereof or combinations of any of the foregoing:

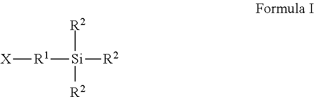

wherein X is a functional group capable to form a bond with the functional group (A) of the latex polymer (a); R¹ is a linking group between the functional group X and the silicon atom or R¹ is a bond; R² independently is a hydrolysable group or a non-hydrolysable group; wherein at least one of R² is a hydrolysable group and at least one of R² is a non-hydrolysable group. The silane compound (b) may be selected from Formula I.

As used herein, the term “non-hydrolysable group” refers to a group that is not cleavable by hydrolysis. Each non-hydrolysable R² can independently be a linear C₁ to C₂₀ alkyl, a linear C₂-C₂₀ alkenyl, a branched or cyclic C₃-C₂₀ alkyl or alkenyl or an aryl. Preferably, each non-hydrolysable R² independently is a linear C₁-C₂₀ alkyl.

As used herein, the term “hydrolysable group” refers to a group that is cleavable by hydrolysis and is capable of forming a Si—OH group when cleaved. Each hydrolysable R² can independently be —H, —OR′, —OC(O)CH₃, OCH₂OCH₃, —SR′, —NHR′, —NR′₂, or -halogen, wherein R′ is a linear C₁-C₆ alkyl, a branched C₃-C₆ alkyl or alkenyl, or an aryl. Preferably, each hydrolysable R² independently is —OR′, or -halogen, wherein R′ is a linear C₁-C₆ alkyl, a branched C₃-C₆ alkyl or alkenyl, or an aryl.

R¹ may be a linking group between the functional group X and the silicon atom. The linking group R¹ between the functional group X and the silicon atom may be a linear C₁-C₂₀ alkanediyl, a branched C₂-C₂₀ alkanediyl, a cyclic C₃-C₂₀ alkanediyl or alkenediyl, or arylenediyl. Preferably, the linking group R¹ between the functional group X and the silicon atom is a linear C₁-C₂₀ alkanediyl. Optionally, one or more methylene group(s) in each of the above alkanediyl, alkenediyl and arylenediyl is/are replaced by a heteroatom, provided that no heteroatom is directly bonded to another heteroatom, and no heteroatom is directly bonded to Si. Preferably, no heteroatom is directly bonded to the functional group X, except when X is glycidyl. The heteroatom preferably is oxygen, sulphur, or nitrogen, more preferably oxygen.

R¹ may be a bond between the functional group X and the silicon atom, preferably only when the functional group X is a carbon-carbon double bond.

According to the present invention, the functional group X may be selected from the group consisting of carbon-carbon double bond, (meth)acryloxy, halide functional group, epoxy, glycidyl, thiol, hydroxy, hydroxylamine, primary amino, secondary amino, isocyanato, oxazolino, aziridino, imino, carbodiimido, glycol, ester, acetoxy, acetoacetoxy, carboxylic acid, dioxolanone, hydrazido, aldehyde, boronic acid, alkoxysilyl and ketone. Preferably, the functional group X may be selected from the group consisting of carbon-carbon double bond, (meth)acryloxy, halide functional group, glycidyl, epoxy, thiol, hydroxy, primary amino, secondary amino, and isocyanato. The functional group X may be selected from the group consisting of glycidyl, epoxy, thiol, hydroxy, primary amino and secondary amino.

The silane compound (b) may be selected from Formula II, oligomers thereof or combinations of any of the foregoing:

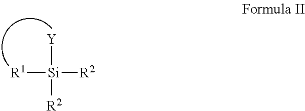

wherein Y is O, S, NH or NR³; wherein R³ is a linear or branched, substituted or unsubstituted alkyl or alkenyl; R¹ is a linking group between the functional group Y and the silicon atom; R² independently is a hydrolysable group or a non-hydrolysable group; wherein at least one of R² is a non-hydrolysable group. The silane compound (b) may be selected from Formula II.

Each non-hydrolysable R² can independently be a linear C₁ to C₂₀ alkyl, a linear C₂-C₂₀ alkenyl, a branched or cyclic C₃-C₂₀ alkyl or alkenyl or an aryl. Preferably, each non-hydrolysable R² independently is a linear C₁-C₂₀ alkyl.

Each hydrolysable R² can independently be —H, —OR′, —OC(O)CH₃, OCH₂OCH₃, —SR′, —NHR′, —NR′₂, or -halogen, wherein R′ is a linear C₁-C₆ alkyl, a branched C₃-C₆ alkyl or alkenyl, or an aryl. Preferably, each hydrolysable R² independently is —OR′, or -halogen, wherein R′ is a linear C₁-C₆ alkyl, a branched C₃-C₆ alkyl or alkenyl, or an aryl.

The linking group R¹ between the functional group Y and the silicon atom may be a linear or branched C₃-C₂₀ alkanediyl. Preferably, the linking group R¹ between the functional group Y and the silicon atom may be a linear or branched C₃-C₁₀ alkanediyl. Optionally, one or more methylene group(s) in each of the above alkanediyl, alkenediyl and arylenediyl is/are replaced by a heteroatom, provided that no heteroatom is directly bonded to another heteroatom, and no heteroatom is directly bonded to Si. Preferably, no heteroatom is directly bonded to the functional group Y. The heteroatom preferably is oxygen, sulphur, or nitrogen, more preferably oxygen.

The Si—Y bond may be hydrolysable forming a Si—OH group and a Y—H group, wherein the Y—H group is a functional group capable to form a bond with the functional group (A) of the latex polymer (a). The functional group Y—H may be —OH, —SH, NH₂ or NHR³; wherein R³ is a linear or branched, substituted or unsubstituted alkyl or alkenyl. The hydrolysis of the Si—Y bond may be achieved in the presence of water and optionally in the presence of a hydrolysis catalyst as described above. The hydrolysis may be performed at a temperature of from 10 to 100° C., preferably from 30 to 80° C., most preferable from 25 to 70° C.

The polymer latex composition of the present invention may comprise the silane compound (b) in an amount of from 0.10 to 4.00 parts by weight, preferably from 0.20 to 2.00 parts by weight, more preferably 0.20 to 1.80 parts by weight, even more preferably 0.20 to 1.50 parts by weight; most preferably 0.40 to 1.50 parts by weight; based on 100 parts by weight of latex polymer (a). Thus, the silane compound (b) may be present in amounts of at least 0.05 parts by weight, at least 0.10 parts by weight, at least 0.15 parts by weight, at least 0.20 parts by weight, at least 0.25 parts by weight, at least 0.30 parts by weight, at least 0.35 parts by weight, at least 0.40 parts by weight, at least 0.45 parts by weight, at least 0.50 parts by weight, at least 0.55 parts by weight, at least 0.60 parts by weight, based on 100 parts by weight of latex polymer (a). Likewise, the silane compound (b) may be present in amounts of up to 4.50 parts by weight, up to 4.00 parts by weight, up to 3.80 parts by weight, up to 3.50 parts by weight, up to 3.20 parts by weight, up to 3.00 parts by weight, up to 2.80 parts by weight, up to 2.50 parts by weight, up to 2.2 parts by weight, up to 2.00 parts by weight, up to 1.80 parts by weight, up to 1.50 parts by weight, based on 100 parts by weight of latex polymer (a). A person skilled in the art will appreciate that any range defined by an explicitly disclosed lower limit and an explicitly disclosed upper limit is disclosed herewith.

The silane compound (b) may be selected from the compounds of Formula I, II or combinations of any of the foregoing. Suitable silane compounds (b) may be selected from the group consisting of (3-glycidoxypropyl) methyl diethoxysilane, (3-glycidoxypropyl) dimethyl ethoxysilane, (3-glycidoxypropyl) methyl dimethoxysilane, 2-(3,4-epoxycyclohexyl)ethyl methyl diethoxysilane, 3-aminopropyl dimethyl methoxysilane, 3-aminopropyl dimethyl ethoxysilane, 3-aminopropyl methyl diethoxysilane, 3-aminopropyl diisopropyl ethoxysilane, 4-amino-3,3-dimethylbutyl methyl dimethoxysilane, (1-aminopropan-2-yl) ethoxy dimethylsilane, N-(2-aminoethyl)-3-aminopropyl methyl diethoxysilane, N-(2-aminoethyl)-3-aminoisobutyl dimethyl methoxysilane, N-(2-aminoethyl)-3-aminopropyl methyl dimethoxysilane, N-(2-aminoethyl)-3-aminoisobutyl methyl dimethoxysilane, (N-cyclohexylaminomethyl) methyl diethoxysilane, N-methylaminopropyl methyl dimethoxysilane, (phenylaminomethyl) methyl dimethoxysilane, 3-(N,N-dimethylaminopropyl)aminopropyl methyl dimethoxysilane, (3-acryloxypropyl) methyl diethoxysilane, (3-acryloxypropyl) methyl dimethoxysilane, (3-acryloxypropyl) dimethyl methoxysilane, (methacryloxymethyl) methyl diethoxysilane, (methacryloxymethyl) methyl dimethoxysilane, (methacryloxymethyl) dimethyl ethoxysilane, (methacryloxypropyl) dimethyl methoxysilane, allylmethyldimethoxysilane, vinylmethyldiethoxysilane, vinylmethyldimethoxysilane, vinyldimethylethoxysilane, (5-bicyclo[2.2.1]hept-2-enyl) methyl diethoxysilane, (5-bicyclo[2.2.1]hept-2-enyl) dimethyl ethoxysilane, (5-bicyclo[2.2.1]hept-2-enyl) methyl dichlorosilane, (mercaptomethyl) methyl diethoxysilane, 3-mercaptopropyl methyl dimethoxysilane, chloromethyl dimethyl ethoxysilane, ((chloromethyl)phenylethyl) methyl dimethoxysilane, 3-chloropropyl dimethyl ethoxysilane, 3-chloropropyl dimethyl methoxysilane, 3-chloroisobutyl dimethyl methoxysilane, chloromethyl dimethyl ethoxysilane, 3-chloropropyl methyl diisopropoxysilane, (3-iodopropyl) methyl diisopropoxysilane, 3-isocyanatopropyl methyl diethoxysilane, 3-isocyanatopropyl methyl dimethoxysilane, 1,1-dimethyl-1-sila-2-oxacyclohexane, 2,2,4-tri methyl-1-oxa-4-aza-2-silacyclohexane, 1-decyl-1-methyl-1-sila-2-oxacyclohexane, 2,2,4-trimethyl-1-thia-2-silacyclopentane, N-(2-aminoethyl)-2,2,4-trimethyl-1-aza-2-silacyclopentane, N-(3-aminopropyldimethylsilyl)aza-2,2-dimethyl-2-silacyclopentane, (N,N-dimethylaminopropyl)-aza-2-methyl-2-methoxysilacyclopentane, and combinations thereof.

Preferably, the silane compound (b) is selected from the group consisting of (3-glycidoxypropyl) methyl diethoxysilane, (3-glycidoxypropyl) dimethyl ethoxysilane, (3-glycidoxypropyl) methyl dimethoxysilane, 2-(3,4-epoxycyclohexyl)ethyl methyl diethoxysilane, 3-aminopropyl dimethyl methoxysilane, 3-aminopropyl dimethyl ethoxysilane, 3-aminopropyl methyl diethoxysilane, 3-aminopropyl diisopropyl ethoxysilane, 4-amino-3,3-dimethylbutyl methyl dimethoxysilane, (1-aminopropan-2-yl) ethoxy dimethylsilane, N-(2-aminoethyl)-3-aminopropyl methyl diethoxysilane, N-(2-aminoethyl)-3-aminoisobutyl dimethyl methoxysilane, N-(2-aminoethyl)-3-aminopropyl methyl dimethoxysilane, N-(2-aminoethyl)-3-aminoisobutyl methyl dimethoxysilane, (N-cyclohexylaminomethyl) methyl diethoxysilane, N-methylaminopropyl methyl dimethoxysilane, (phenylaminomethyl) methyl dimethoxysilane, 3-(N,N-dimethylaminopropyl)aminopropyl methyl dimethoxysilane, (mercaptomethyl) methyl diethoxysilane, 3-mercaptopropyl methyl dimethoxysilane, 1,1-dimethyl-1-sila-2-oxacyclohexane, 2,2,4-trimethyl-1-oxa-4-aza-2-silacyclohexane, 1-decyl-1-methyl-1-sila-2-oxacyclohexane, 2,2,4-trimethyl-1-thia-2-silacyclopentane, N-(2-aminoethyl)-2,2,4-trimethyl-1-aza-2-silacyclopentane, N-(3-aminopropyldimethylsilyl)aza-2,2-dimethyl-2-silacyclopentane, (N,N-dimethylaminopropyl)-aza-2-methyl-2-methoxysilacyclopentane, and combinations thereof.

According to the present invention, the bond formed between the functional group (A) of the latex polymer (a) and the functional group X of the silane compound (b) may be selected from the group consisting of disulfide, tetrasulfide, carbonate, urea, thiourea, ester, beta-hydroxy ester, thioester, beta-hydroxy amine, beta-hydroxy thioether, amide, urethane, enamine, imine, hemiacetal, acetal, hemiketal, ketal, boronate ester, siloxane, oxime, acylhydrazone, aldol, thiuram disulfide and trithiocarbonate. Preferably, the bond formed between the functional group (A) of the latex polymer (a) and the functional group X of the silane compound (b) is selected from the group consisting of ester, beta-hydroxy ester, thioester, amide, enamine and imine.

According to the present invention, the bond formed between the functional group (A) of the latex polymer (a) and the functional group Y—H of the silane compound (b) may be selected from disulfide, tetrasulfide, carbonate, urea, thiourea, ester, beta-hydroxy ester, thioester, amide, urethane, enamine, imine, hemiacetal, acetal, hemiketal, ketal, and boronate ester.

Preferably, the bond formed between the functional group (A) of the latex polymer (a) and the functional group Y—H of the silane compound (b) is selected from the group consisting of ester, beta-hydroxy ester, thioester, amide, enamine and imine.

The bond formed between the functional group (A) of the latex polymer (a) and the functional group X and/or Y—H of the silane compound (b) may be a thermally reversible bond. As used herein, the term “thermally reversible bond” refers to a chemical link between two functional groups that results from a temperature-dependent equilibrium-based chemical reaction wherein the chemical link forms at low temperatures, but is reversibly driven to disruption and rearrangement as the temperature is increased. According to the present invention, the thermally reversible bond may be formed at a temperature of or less than 200° C., preferably of or less than 180° C., more preferably of or less than 160° C. Typically, the thermally reversible bond may be formed at a temperature range of from 25 to 200° C. According to the present invention, the thermally reversible bond is capable to disrupt at a temperature of or less than 200° C., preferably of or less than 190° C., more preferably of or less than 180° C. and rearrange to form a thermally reversible bond. Typically, the thermally reversible bond may be capable to disrupt and rearrange at a temperature range of from 25 to 200° C.

The functional groups (A) of the latex polymer (a) and the functional groups of the silane compound (b) for a bond to be formed may be selected to provide the following combinations:
the functional groups (A) of the latex polymer (a) may be selected from groups having a carbon-carbon double bond and the functional groups of the silane compound (b) may be selected from groups having carbon-carbon double bonds, (meth)acryloxy, and thiol;
the functional groups (A) of the latex polymer (a) may be selected from carboxylic acid functional groups and the functional groups of the silane compound (b) may be selected from epoxy, glycidyl, thiol, hydroxy, primary or secondary amino, isocyanato, oxazolino, aziridino, imino, carbodiimido, glycol groups, ester groups, and acetoxy;
the functional groups (A) of the latex polymer (a) may be selected from hydroxy and the functional groups of the silane compound (b) may be selected from carboxylic acid functional groups, isocyanato, primary or secondary amino, aldehyde, boronic acid and ester groups;
the functional groups (A) of the latex polymer (a) may be selected from epoxy and the functional groups of the silane compound (b) may be selected from carboxylic acid functional groups, hydroxy and ester groups;
the functional groups (A) of the latex polymer (a) may be selected from glycidyl and the functional groups of the silane compound (b) may be selected from carboxylic acid functional groups, hydroxy and ester groups;
the functional groups (A) of the latex polymer (a) may be selected from acetoacetoxy and the functional groups of the silane compound (b) may be selected from groups having carbon-carbon double bonds, (meth)acryloxy, isocyanato, aldehyde, hydrazine, hydrazide, and primary or secondary amino;
the functional groups (A) of the latex polymer (a) may be selected from primary or secondary amino and the functional groups of the silane compound (b) may be selected from carboxylic acid functional groups, epoxy, glycidyl, ester groups and dioxolanone groups;
the functional groups (A) of the latex polymer (a) may be selected from acetoxy and the functional groups of the silane compound (b) may be selected from hydrazido and primary or secondary amino;
the functional groups (A) of the latex polymer (a) may be selected from isocyanato and the functional groups of the silane compound (b) may be selected from carboxylic acid functional groups. hydroxy, primary or secondary amino and thiol;
the functional groups (A) of the latex polymer (a) may be selected from alkoxysilyl and the functional groups of the silane compound (b) may be selected hydroxy and alkoxysilyl;
the functional groups (A) of the latex polymer (a) may be selected from alkoxy and the functional groups of the silane compound (b) may be selected from ester groups;
the functional groups (A) of the latex polymer (a) may be selected from ester groups and the functional groups of the silane compound (b) may be selected from hydroxy, carboxylic acid groups and ester groups;
the functional groups (A) of the latex polymer (a) may be selected from dioxolanone groups and the functional groups of the silane compound (b) may be selected from primary or secondary amino;
the functional groups (A) of the latex polymer (a) may be selected from halide functional groups and the functional groups of the silane compound (b) may be selected from carboxylic acids;
the functional groups (A) of the latex polymer (a) may be selected from thiol functional groups and the functional groups of the silane compound (b) may be selected from carbon-carbon double bond, (meth)acryloxy, carboxylic acid functional groups, or isocyanato;
the functional groups (A) of the latex polymer (a) may be selected from hydroxylamine and the functional groups of the silane compound (b) may be selected from aldehyde;
the functional groups (A) of the latex polymer (a) may be selected from oxazolino and the functional groups of the silane compound (b) may be selected from carboxylic acid;
the functional groups (A) of the latex polymer (a) may be selected from aziridino and the functional groups of the silane compound (b) may be selected from carboxylic acid or hydroxy;
the functional groups (A) of the latex polymer (a) may be selected from imino and the functional groups of the silane compound (b) may be selected from carboxylic acid;
the functional groups (A) of the latex polymer (a) may be selected from carbodiimino and the functional groups of the silane compound (b) may be selected from carboxylic acid;
the functional groups (A) of the latex polymer (a) ma be selected from glycol groups and the functional groups of the silane compound (b) may be selected from carboxylic acid functional groups;
the functional groups (A) of the latex polymer (a) may be selected from hydrazido and the functional groups of the silane compound (b) may be selected from aldehyde;
the functional groups (A) of the latex polymer (a) may be selected from aldehyde and the functional groups of the silane compound (b) may be selected from hydroxy, acetoacetoxy, hydroxylamine, or hydrazido; or
the functional groups (A) of the latex polymer (a) may be selected from ketone and the functional groups of the silane compound (b) may be selected from hydroxy.

### Silane Compound (c) Different to Silane Compound (b)

The polymer latex composition of the present invention may further comprise a silane compound (c), which is different to silane compound (b). The silane compound (c) may be selected from the compounds of Formula III, IV, oligomers thereof or combinations of any of the foregoing:

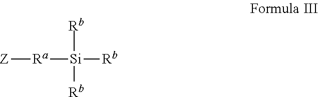

wherein Z is a functional group capable to form a bond with the functional group (A) of the latex polymer (a); R^{a} is a linking group between the functional group Z and the silicon atom or R^{a} is a bond; R^{b} is a hydrolysable group;

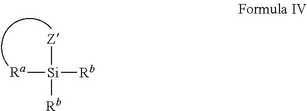

wherein Z′ is O, S, NH or NR³; wherein R³ is a linear or branched, substituted or unsubstituted alkyl or alkenyl; R^{a} is a linking group between the functional group Z′ and the silicon atom; R^{b} is a hydrolysable group.

The oligomers of the silane compound (c) may be achieved as described above. Further another suitable method for preparing such oligomers is described in more detail in EP 3 628 700 A1, specifically in paragraphs [0026] to [0030] and [0048]. Suitable examples of oligomers of compounds of Formula III, IV includes CoatOSil MP-200 and CoatOSil T-Cure, both commercially available from Momentive Performance Materials Inc. (USA); and Dynsylan VPS4721 and Dynasylan 6490, both commercially available from Evonik Industries AG (Germany).

The Si—Z′ bond may be hydrolysable forming a Si—OH group and a Z′—H group, wherein the Z′—H group is a functional group capable to form a bond with the functional group (A) of the latex polymer (a). The functional group Z′—H may be —OH, —SH, NH₂ or NHR³; wherein R³ is a linear or branched, substituted or unsubstituted alkyl or alkenyl. The hydrolysis of the Si—Z′ bond may be achieved in the presence of water and optionally in the presence of a hydrolysis catalyst as described above. The hydrolysis may be performed at a temperature of from 10 to 100° C., preferably from 15 to 80° C., most preferably from 25 to 70° C.

Each hydrolysable R^{b} can independently be —H, —OR′, —OC(O)CH₃, —OCH₂OCH₃, —SR′, —NHR′, —NR′₂, or -halogen, wherein R′ is a linear C₁-C₆ alkyl, a branched C₃-C₆ alkyl or alkenyl, or an aryl. Preferably, each hydrolysable R^{b} independently is —OR′, or -halogen, wherein R′ is a linear C₁-C₆ alkyl, a branched C₃-C₆ alkyl or alkenyl, or an aryl.

R^{a} may be a linking group between the functional group Z and the silicon atom. The linking group R^{a} between the functional group Z and the silicon atom may be a linear C₁-C₂₀ alkanediyl, a branched C₂-C₂₀ alkanediyl, a cyclic C₃-C₂₀ alkanediyl or alkenediyl, or arylenediyl. Preferably, the linking group R^{a} between the functional group Z and the silicon atom is a linear C₁-C₂₀ alkanediyl. Optionally, one or more methylene group(s) in each of the above alkanediyl, alkenediyl and arylenediyl is/are replaced by a heteroatom, provided that no heteroatom is directly bonded to another heteroatom, and no heteroatom is directly bonded to Si. Preferably, no heteroatom is directly bonded to the functional group Z, except when Z is glycidyl. The heteroatom preferably is oxygen, sulphur, or nitrogen, more preferably oxygen.

R^{a} may be a bond between the functional group Z and the silicon atom, preferably only when the functional group Z is a carbon-carbon double bond.

According to the present invention, the functional group Z may be selected from the group consisting of carbon-carbon double bond, (meth)acryloxy, halide functional group, epoxy, glycidyl, thiol, hydroxy, hydroxylamine, primary amino, secondary amino, isocyanato, oxazolino, aziridino, imino, carbodiimido, glycol, ester, acetoxy, acetoacetoxy, carboxylic acid, dioxolanone, hydrazido, aldehyde, boronic acid, alkoxysilyl and ketone. Preferably, the functional group Z may be selected from the group consisting of carbon-carbon double bond, (meth)acryloxy, halide functional group, glycidyl, epoxy, thiol, hydroxy, primary amino, secondary amino, and isocyanato; more preferably from the group consisting of glycidyl, epoxy, thiol, hydroxy, primary amino and secondary amino.

The linking group R^{a} between the functional group Z′ and the silicon atom may be a linear or branched C₃-C₂₀ alkanediyl. Preferably, the linking group R^{a} between the functional group Z′ and the silicon atom may be a linear or branched C₃-C₁₀ alkanediyl. Optionally, one or more methylene group(s) in each of the above alkanediyl, alkenediyl and arylenediyl is/are replaced by a heteroatom, provided that no heteroatom is directly bonded to another heteroatom, and no heteroatom is directly bonded to Si. Preferably, no heteroatom is directly bonded to the functional group Z′. The heteroatom preferably is oxygen, sulphur, or nitrogen, more preferably oxygen.

Suitable examples of silane compound (c) may be selected from the group consisting of (3-glycidyloxypropyl) trialkoxysilane, beta-(3,4-epoxycyclohexylethyl trialkoxysilane), dialkoxy (3-glycidyloxypropyl)alkylsilane, 3-glycidoxypropyldialkylalkoxysilane, 5,6-epoxyhexyltrialkoxysilane, 2-(3,4-epoxycyclohexyl)ethyl trialkoxysilane, (meth)acryl propyl trialkoxysilane, (meth)acryl methyl trialkoxysilane, 3-amino propyl trialkoxysilane, 4-amino butyl trialkoxysilane, 4-amino-3,3-dimethylbutyl trimethoxysilane, 11-amino undecyl trialkoxysilane, aminophenyl trialkoxysilane, aminophenoxy trialkoxysilane, N-alkyl aminopropyl trialkoxysilane, N-(2-aminoethyl)-3-aminopropyl trialkoxysilane, N-(6-aminohexyl)aminomethyl trialkoxysilane, N-(2-aminoethyl)-11-aminoundecyl trialkoxysilane, N-3-[(amino(polypropylenoxy)]aminopropyl trialkoxysilane, (3-trialkoxysilylpropyl)diethylenetriamine, 3-(N-allylamino)propyl trialkoxysilane, N-butylaminopropyl trialkoxysilane, t-butylaminopropyl trialkoxysilane, (N-cyclohexylaminomethyl) trialkoxysilane, (N-cyclohexylaminopropyl) trialkoxysilane, (3-(N-ethylamino)isobutyl) trialkoxysilane, N-methylaminopropyl trialkoxysilane, N-phenylaminomethyl trialkoxysilane, N-phenylaminopropyl trialkoxysilane, N-(2-N-benzylaminoethyl)-3-aminopropyl trialkoxysilane, hydroxymethyl trialkoxysilane, N,N-bis(2-hydroxyethyl)-3-aminopropyl triethoxysilane, 3-mercaptopropyltrialkoxysilane, 11-mercaptoundecyl trialkoxysilane, 2,2-dialkoxy-1-thia-2-silacyclopentane, chloromethyl trialkoxysilane, 3-chloropropyl trialkoxysilane, 3-chloroisobutyl trialkoxysilane, 11-chloroundecyl trialkoxysilane, ((chloromethyl)phenylethyl) trialkoxysilane, 2-(chloromethyl)allyl trimethoxysilane, 3-bromopropyl trialkoxysilane, 4-bromobutyl trialkoxysilane, 5-bromopentyl trialkoxysilane, 7-bromoheptyl trialkoxysilane, 11-bromoundecyl trialkoxysilane, 3-iodopropyl trialkoxysilane, allyl trialkoxysilane, vinyl trialkoxysilane, 11-allyloxyundecyl trialkoxysilane, allylphenylpropyl trialkoxysilane, 3-butenyl triethoxysilane, 5-hexenyl trialkoxysilane, 7-octenyl trialkoxysilane, styrylethyl trialkoxysilane, 10-undecenyl trialkoxysilane, [(5-bicyclo[2.2.1]hept-2-enyl)ethyl]trialkoxysilane, (5-bicyclo[2.2.1]hept-2-enyl) trialkoxysilane, [2-(3-cyclohexenyl)ethyl]trialkoxysilane, [2-(3-cyclohexenyl)ethyl]trialkoxysilane, docosenyl trialkoxysilane, 3-(trialkoxysilyl)furan, norbornenyl trialkoxysilane, 3-isocyanatopropyl trialkoxysilane, tris[3-(trialkoxysilyl)propyl]isocyanurate, trialkoxysilyl butyraldehyde, trialkoxysilylundecanal, ureidopropyl trialkoxysilane, cyanomethyl [3-(trialkoxysilyl)propyl]trithiocarbonate, S-(octanoyl) mercaptopropyl trialkoxysilane, N-allyl-aza-2,2-dimethoxysilacyclopentane, N—N-butyl-aza-2,2-dimethoxysilacyclopentane, 2,2-dimethoxy-1,6-diaza-2-silacyclooctane, 1-ethyl-2,2-dimethoxy-4-methyl-1-aza-2-silacyclopentane, methacryloxy propyl tris(methoxyethoxy) silane, vinyltriacetoxysilane, vinyltriisopropenoxysilane, and combinations thereof. The alkoxy groups in the respective examples of silane compound (c) preferably are selected from methoxy, ethoxy, propoxy, butoxy, and combinations thereof, more preferably from methoxy, ethoxy, and combinations thereof.

When the silane compound (c) is present in the polymer latex composition of the present invention, the mass ratio of the silane compound (c) and the silane compound (b) may be from 1:40 to 40:1, preferably from 1:30 to 30:1, more preferably from 1:20 to 20:1, even more preferably from 1:20 to 10:1, most preferably from 1:20 to 2:1.

The polymer latex composition of the present invention may comprise the silane compound (c) in an amount of up to 4.00 parts by weight, preferably up to 3.00 parts by weight, more preferably up to 2.00 parts by weight, even more preferably up to 1.50 parts by weight; most preferably up to 1.00 parts by weight; based on 100 parts by weight of latex polymer (a). The silane compound (c) may be present in amounts of up to 4.00 parts by weight, up to 3.50 parts by weight, up to 3.00 parts by weight, up to 2.00 parts by weight, up to 1.50 parts by weight, up to 1.00 parts by weight, up to 0.80 parts by weight, up to 0.5 parts by weight, based on 100 parts by weight of latex polymer (a).

The polymer latex composition of the present invention may comprise the silane compound (b) and the silane compound (c) in a combined amount of from 0.10 to 5.00 parts by weight; preferably from 0.20 to 5.00 parts by weight; more preferably from 0.20 to 4.50 parts by weight; even more preferably from 0.20 to 4.00 parts by weight; based on 100 parts by weight of latex polymer (a). Thus, the silane compound (b) and the silane compound (c) may be present in combined amounts of at least 0.05 parts by weight, at least 0.10 parts by weight, at least 0.15 parts by weight, at least 0.20 parts by weight, at least 0.25 parts by weight, at least 0.30 parts by weight, at least 0.35 parts by weight, at least 0.40 parts by weight, at least 0.45 parts by weight, at least 0.50 parts by weight, at least 0.55 parts by weight, at least 0.60 parts by weight, based on 100 parts by weight of latex polymer (a).

Likewise, the silane compound (b) and the silane compound (c) may be present in combined amounts of up to 5.00 parts by weight, up to 4.50 parts by weight, up to 4.00 parts by weight, up to 3.80 parts by weight, up to 3.50 parts by weight, up to 3.20 parts by weight, up to 3.00 parts by weight, up to 2.80 parts by weight, up to 2.50 parts by weight, up to 2.2 parts by weight, up to 2.00 parts by weight, up to 1.80 parts by weight, up to 1.50 parts by weight, based on 100 parts by weight of latex polymer (a). A person skilled in the art will appreciate that any range defined by an explicitly disclosed lower limit and an explicitly disclosed upper limit is disclosed herewith.

### Preparation of the Latex Composition

The present invention further relates to a method for preparation of a polymer latex composition according to the present invention. The method comprises (i) polymerizing in an emulsion polymerization process a monomer composition comprising ethylenically unsaturated monomers for latex polymer (a) comprising at least one monomer resulting after polymerization in a functional group (A) to obtain a latex comprising particles of latex polymer (a) comprising functional groups (A); and (ii) adding a silane compound (b) selected from the compounds of Formula I, II, oligomers thereof or combinations of any of the foregoing:

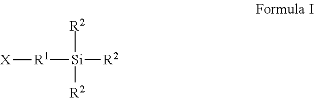

wherein X is a functional group capable to form a bond with the functional group (A) of the latex polymer (a); R¹ is a linking group between the functional group X and the silicon atom or R¹ is a bond; R² independently is a hydrolysable group or a non-hydrolysable group; wherein at least one of R² is a hydrolysable group and at least one of R² is a non-hydrolysable group;

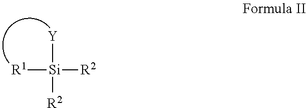

wherein Y is O, S, NH or NR³; wherein R³ is a linear or branched, substituted or unsubstituted alkyl or alkenyl; R¹ is a linking group between the functional group Y and the silicon atom; R² independently is a hydrolysable group or a non-hydrolysable group; wherein at least one of R² is a non-hydrolysable group.

Optionally, the method comprises (iii) adding a silane compound (c) different to silane compound (b), wherein the silane compound (c) is selected from the compounds of Formula III, IV, oligomers thereof or combinations of any of the foregoing:

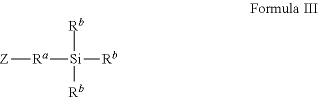

wherein Z is a functional group capable to form a bond with the functional group (A) of the latex polymer (a); R^{a} is a linking group between the functional group Z and the silicon atom or R^{a} is a bond; R^{b} is a hydrolysable group;

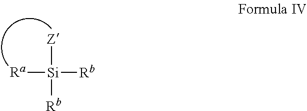

wherein Z′ is O, S, NH or NR³; wherein R³ is a linear or branched, substituted or unsubstituted alkyl or alkenyl; R^{a} is a linking group between the functional group Z′ and the silicon atom; R^{b} is a hydrolysable group. The silane compound (c) may be added before, during or after the addition of silane compound (b).

All the variations with respect to the monomer composition to obtain the particle of a latex polymer (a); functional groups (A) of the polymer latex (a); functional groups X of the silane compound (b); functional group Z of the silane compound (c); the hydrolysable groups R² and R^{b}; the non-hydrolysable group R², the linking groups R¹ and R^{a}, the relative amounts of the silane compounds (b) and (c); and the mass ratios of the silane compounds (b) and (c) as described above may be used.

### Compounded Latex Composition and Method for Making Dip-Molded Articles and Elastomeric Films

The present invention also relates to use of the polymer latex composition of the present invention or prepared by the method of the present invention for the production of dip-molded articles, an elastomeric film, a self-supporting elastomeric film or article or for coating or impregnating a substrate. Preferably, the substrate is a textile substrate.

In addition, the invention relates to a compounded polymer latex composition suitable for the production of dip-molded articles. The compounded latex composition of the present invention comprises the polymer latex composition of the present invention or the polymer latex composition prepared by the method of the present invention.

To get reproducible good physical film properties, it is advisable to adjust the pH of the compounded polymer latex composition by pH modifiers to be in the range of pH 7 to 11, preferably 8 to 10, more preferred 9 to 10, for dipping to produce thin disposable gloves. For producing unsupported and/or supported reusable gloves, it is advisable to adjust the pH of the compounded polymer latex composition by pH modifiers to be in the range of pH 8.0 to 12.0, preferably 9.0 to 11.5. The pH value of the compounded polymer latex composition may be adjusted using a pH modifier selected from sodium hydroxide, potassium hydroxide, and ammonia solution. Preferably, the pH value of the polymer latex composition may be adjusted using potassium hydroxide.

Optionally, the compounded polymer latex composition comprises adjuvants selected from sulfur vulcanization agents, accelerators for vulcanization, free-radical initiators, pigments and combinations thereof. The compounded latex composition may further comprise polyvalent cations and/or silica-based fillers. Suitable silica-based fillers include fumed silica and precipitated silica.

It is possible to add conventional vulcanization systems to the compounded polymer latex composition according to the present invention to be used in dip-molding processes, such as sulfur in combination with accelerators, such as thiurams and carbamates and zinc oxide to make it curable. Alternatively, or additionally, a crosslinker component like, for example, polyvalent cations or other polyfunctional organic compounds suitable to react with functional groups on the latex particles in order to achieve chemical crosslinking may be added. Preferably, polyvalent cations and/or silica-based fillers can be added to the latex composition according to the present invention. Suitable polyvalent cations include metal oxides, preferably zinc oxide, magnesium oxide, iron oxides.

However, it is a particular advantage of the present invention that the compounded latex composition of the present invention can be free of sulfur vulcanization agents and accelerators for sulfur vulcanization, and the polymer latex compound of the present invention is still curable to provide dip-molded articles having the required tensile properties. It is preferred to use polyvalent cations for example ZnO as additional crosslinker component to appropriately adjust the mechanical properties in particular of very thin elastomeric films having a film thickness of 0.1 mm at most, preferably of 0.01 to 0.1 mm, more preferred 0.03 to 0.08 mm.

Suitably, the polyvalent cations may be present in amounts up to 20 wt.-%, based on the total weight of the particles of the latex polymer (a), the silane compound (b), and if present the silane compound (c).

In certain heavy-duty applications like industrial gloves, it might be advantageous to employ, in addition to the self-crosslinking properties of the polymer latex of the present invention, conventional sulfur vulcanization systems as described above in order to further increase the mechanical strength of the dip-molded articles.

The present invention relates to a method for making dip-molded articles. The method comprises (a) providing a compounded latex composition according to the present invention. The method further comprises (b) immersing a mold having the desired shape of the final article in a coagulant bath comprising a solution of a metal salt. The coagulant is usually used as a solution in water, an alcohol or a mixture thereof. As specific examples of the coagulant the metal salts can be metal halides like calcium chloride, magnesium chloride, barium chloride, zinc chloride and aluminum chloride; metal nitrates such as calcium nitrate, barium nitrate and zinc nitrate; metal sulfates like calcium sulfate, magnesium sulfate, and aluminum sulfate; and acetic acid salts such as calcium acetate, barium acetate and zinc acetate. Most preferred are calcium chloride and calcium nitrate. The coagulant solution might contain additives to improve the wetting behavior of the former.

The method for making dip-molded articles further comprises (c) removing the mold from the coagulant bath and optionally drying the mold; (d) immersing the mold as treated in step (b) and (c) in the compounded latex composition of step (a); and (e) coagulating a latex film on the surface of the mold. It is possible to obtain the latex film by a plurality of dipping steps, particularly two dipping steps in sequence.

Thereafter, the method for making dip-molded articles further comprises (f) removing the latex-coated mold from the compounded latex composition and optionally immersing the latex-coated mold in a water bath. The latex-coated mold may be immersed in a water bath in order to extract, for example, polar components from the composition and to wash the coagulated latex film.

Thereafter, the latex-coated mold is optionally dried (g), preferably at temperatures below 80° C. Finally, the method for making dip-molded articles comprises (h) heat treating the latex-coated mold obtained from step (e) or (f) at a temperature of 40° C. to 180° C., such as at temperatures of 40 to 160° C., or 40 to 150° C., or 40 to 130° C.; and/or exposing the latex-coated mold obtained from step (e) or (f) to UV radiation. Then, the final latex film is removed from the mold (i). The duration of the heat treatment will depend on the temperature and is typically between 1 and 60 minutes. The higher the temperature, the shorter is the required treatment time.

The present invention further relates to a method for the production of a continuous elastomeric film. The method comprises (A) providing a polymer latex composition according to the present invention or prepared by the method according to the present invention; (B) forming from the aqueous polymer latex composition a continuous polymer film, for example by a casting process. The method for the production of a continuous elastomeric film further comprises (C) optionally drying the continuous polymer film obtained in step (B); and (D) heat treating the continuous polymer film obtained in step (B) or (C) at a temperature of 40° C. to 180° C. preferably for 20 min or less to form a continuous elastomeric film; and/or UV treating. Optionally, the method for the production of a continuous elastomeric film further comprises (E) rolling the continuous elastomeric film obtained in step (D) into a roll.

As an alternative a cut and seal process may be used. The present invention relates to a process for making an elastomeric article by aligning two separate continuous elastomeric films obtained according to the method for the production of a continuous elastomeric film as described above; cutting the aligned continuous elastomeric films into a preselected shape to obtain two superposed layers of the elastomeric films in the preselected shape; and joining together the superposed layers of elastomeric film at least a preselected part of the periphery of the superposed layers to form an elastomeric article.

The joining together may be performed by using thermal means, preferably selected from heat sealing and welding or by gluing or a combination of heating and gluing. The cutting may be performed by a heatable template cutting device or laser cutter, providing the preselected shape and the cutting device may be heated in the sections that contact the elastomeric films where the films are joined together, thereby simultaneously cutting the elastomeric films into the preselected shape and heat sealing the preselected parts of the periphery of the superposed elastomeric films.

Moreover, the present invention further relates to a method for repairing or reforming an elastomeric film or an article comprising said elastomeric film by (a) providing a film or article comprising an elastomeric film or films, having at least two surfaces to be reconnected, (b) re-joining the at least two surfaces of the elastomeric film(s), and heating or annealing the elastomeric film(s) while maintaining intimate contact of the rejoined surfaces of the damaged film at a temperature of 40 to 200° C., preferably 60 to 175° C., more preferably 95 to 135° C., wherein (c) the elastomeric film is made from a polymer latex composition according to the present invention or prepared by the method according to the present invention.

The present invention relates to articles made by using the polymer latex composition of the present invention or prepared by the method of the present invention or the compounded latex composition of the present invention. The article may be selected from surgical gloves, examination gloves, industrial gloves, household gloves, single-use gloves, textile supported gloves, catheters, elastomeric sleeves, condoms, balloons, tubing, dental dam, apron and pre-formed gasket.

The present invention will be further illustrated with reference to the following examples.

### EXAMPLES

| | |
|---|---|
| Latex polymer | Commercially available Carboxylated-Nitrile- |
| | Butadiene-Rubber (XNBR) grade latices from |
| | Synthomer Sdn. Bhd (Malaysia) was used in |
| | the examples |
| Crosslinker 1 | [3-(2,3-epoxypropoxy)-propyl]-trimethoxysilane |
| Crosslinker 2 | [3-(2,3-epoxypropoxy)-propyl]-methyldiethoxysilane |

### Latex Composition Preparation of Cured Films

### Latex Composition Preparation A (Pot-Life)—Accelerator-Free Latex

Compounding materials zinc oxide (ZnO) and titanium dioxide (TiO₂), as well as Crosslinker 1 or Crosslinker 2 were added under stirring to the latex polymer. The ZnO and TiO₂ used were dispersions The composition was stirred and the pH was adjusted to pH 9.5-10.0 by adding a 5% potassium hydroxide solution in water, diluted to a total solid content of 18% and matured under continuous stirring at 25° C. (±2) for at least 16 hours. A compounded latex from Latex Composition Preparation A is obtained. The compounded latex is then used immediately (0 month elapsed) or stored for 33 days (1 month elapsed) at 25° C. (+2) before the next step, Former Dipping. A long-elapsed time of more than 1 month is chosen to demonstrate the robustness of crosslinkers used.

### Latex Composition Preparation B (Shelf-Life)—Accelerator-Free Latex

Latex Composition Preparation B was exactly like Latex Composition Preparation A, except that Crosslinker 1 and Crosslinker 2 were pre-added before the compounding materials were added into respective latexes. Latex with pre-added Crosslinker 1 and 2 are used immediately (0 month elapsed) or stored at 25° C. (+2) for an elapsed time period of 89 days (3 months elapsed) and 186 days (6 months elapsed). After the elapsed time period, compounding materials are added and matured as usual. A compounded latex from Latex Composition Preparation B is obtained. A long-elapsed time of 3 months and 6 months are chosen to demonstrate the robustness of pre-added crosslinkers in the latex.

### Latex Composition Preparation C (Sulphur-Accelerator Nitrile Latex Only)—Sulphur-Vulcanized Latex

Latex Composition Preparation C was exactly like Latex Composition Preparation A, except that Crosslinker 1 and Crosslinker 2 were not used. Instead, a sulphur vulcanization system containing an accelerator and sulphur were used. Sulphur dispersion and accelerator dispersion, zinc diethyldithiocarbamate (ZDEC) were used, which were added into the latex and the latex were prepared and used immediately.

The composition of Latex Composition Preparations A, B and C are summarized in Table 1 as Examples (Ex.) and Comparative Examples (CE) in parts per hundred rubber (phr).

TABLE 1
Composition of Latex Used in Compounding

| Parts (phr) | Ex. 1 | Ex. 2 | Ex. 3 | Ex. 4 | CE 1 | CE 2 |
|---|---|---|---|---|---|---|
| Nitrile Latex | 100.0 | 100.0 | 100.0 | 100.0 | 100.0 | 100.0 |
| Latex Composition | A | A & B | A | A | C | A & B |
| Preparation | | | | | | |
| ZnO | 1.0 | 1.0 | 1.0 | 1.0 | 1.0 | 1.0 |
| TiO₂ | 1.0 | 1.0 | 1.0 | 1.0 | 1.0 | 1.0 |
| Sulphur | — | — | — | — | 0.8 | — |
| Accelerator | — | — | — | — | 0.7 | — |
| Crosslinking Agent 1 | — | — | — | — | — | 0.6 |
| Crosslinking Agent 2 | 0.2 | 0.6 | 1.2 | 4.0 | — | — |

### Former Dipping

Dipping was conducted manually or using an automatic film, spade and glove dipping machine (commercially available from Kendek Products Sdn Bhd. (Malaysia)). A liner glove was fitted to a former and the former was conditioned in an air circulated oven at 70° C., then dipped into a coagulant solution comprising an aqueous solution comprising 18-20 wt. % of calcium nitrate and 2-3 wt. % of calcium carbonate at 60° C. for 1 sec. The former is then placed in an oven set at 75-85° C. for a certain time then dipped into respective Latex Compositions A, B or C at former temperature of 60-65° C. for a set time, withdrawn and kept turning to avoid formation of liquid droplets to obtain a latex-dipped former. The latex-dipped former was then gelled in the oven for 1 minute at 100° C., film-beaded and leached into deionized water leaching tank for 1 minute at 50-60° C. followed by curing in the oven at 95 or 120° C. for 20 minutes. Finally, a cured latex glove was manually stripped from the former. The gloves were conditioned in the climate room at 23° C. (±2) at 50% (±5) relative humidity for at least 16 hours before other physical tests.

### Determination of Tensile Properties (ASTM D6319 and EN 455)

The tensile properties of the final gloves or films were tested according to American Society for Testing and Materials (ASTM) and European Standards (EN) as specified in test procedures ASTM D6319 and EN455. Dumbbell specimens were cut from palm area of gloves or films prepared from each latex compound. The unaged and aged samples (“aged” refers to specimens which are placed in an oven for 22 h at 100° C. before tensile properties are tested) were conditioned at 23±2° C. and 50±5% relative humidity for 24 hours prior to testing on the extensometer. The film thickness (mm) was measured with a typical film thickness value between 0.055-0.075 mm. The reported tensile strength (TS) corresponds to the determined maximum tensile stress in stretching the specimen to rupture. The elongation at break (EB) corresponds to the elongation at which rupture occurs. While Modulus 100, 300 and 500 corresponds to the determined tensile stress in stretching the specimen at 100, 300 and 500% elongation. The reported TS, EB, Modulus 100, 300 and 500, conducted in accordance to ASTM D6319 test procedure. Finally, the force at break (FAB) corresponds to the force at which rupture occurs, conducted in accordance to EN455.

A prepared Latex Composition Preparation A, B or C used immediately or stored for an elapsed amount of time, cured either at 95 or 120° C., shall have tensile strength (TS) of 20 MPa or more, the elongation at break (EB) between 500 to 750%, and the 100% modulus (M100) in the range of 3 to 10 MPa.

### Determination of Fatigue Durability

The former dipped gloves to be tested were cut using scissors in a straight line from the crotch between index and middle finger to the cuff line below the thumb. The thumb and finger sample cut were kept along the outside edge to a point at the tip of the thumb. The sample was opened, and the tip of the index finger was attached into the top jaws of the automated stress and relaxation equipment and the clamp was shut. The lower area of the sample was attached between the jaws at the lower clamp and the clamp was shut. The free “wing” of the sample was attached to the sidebars of the test equipment by using masking tape. The test equipment was positioned into the beaker containing pH adjusted deionized water using 5% citric acid solution to pH 4 so that the crotch between the thumb and index finger was fully immersed in the aqueous acid solution. The test equipment was set to zero (0) and the test was started. The test was conducted at 25° C. The measurement stopped automatically when the sample broke and the number of cycles required to reach break point were recorded. The test was repeated 5 times to allow an average to be calculated, whereby fresh citric acid solution was used for each test. The reported durability (in minutes) corresponds to the average number of cycles (average number of cycles required to cause the sample failure) divided by 267 (total cycle per hour). The test was stopped after 5 hours or until failure.

Determination of Pot-Life and Shelf-Life from Fatigue Durability

Pot-life and shelf-life refer to usable period in which the obtained cured film can meet specific criteria i.e. wherein the fatigue durability is preferably 60 min or more. The specific criteria will be further specified below.

Specifically, pot-life refers to usable period of compounded latex i.e. from the Latex Compounding and Maturation to the production of cured film for Latex Composition Preparation (A); wherein the fatigue durability is 60 min or more. A fatigue durability comparison is made for Composition Preparation (A), after 0 day (no storage and used immediately) and after 33 days (1 Month) of Latex Compounding and Maturation.

Specifically, shelf-life refers to the usable period of latexes containing pre-added Crosslinker 1 or 2 i.e. from the pre-addition of Crosslinker 1 or 2, to the production of cured film for Latex Composition Preparation (B); wherein the fatigue durability is 60 min or more. A fatigue durability comparison is made for Composition Preparation (B), after 0 day (no storage and used immediately), after 89 days (3 Months) and after 186 days (6 Months) pre-addition of Crosslinker 1 or 2.

The tensile data for the as-prepared examples and comparative examples described above were measured and summarized in Tables 2 to 11.

TABLE 2
Unaged results for compositions Ex. 1 to 4 and CE 2, 0 month elapsed compounded latEx.

| | | | Crosslinker | | ASTM D6319 | | | | | | EN 455 | |
|---|---|---|---|---|---|---|---|---|---|---|---|---|
| | Latex | Curing | | Parts | Thickness | TS | EB | Modulus | | | Thickness | FAB |
| Sample | Prep. | Condition | Type | (phr) | (mm) | (MPa) | (%) | 100 | 300 | 500 | (mm) | (N) |
| CE2 | A | 70° C.; | Crosslinker 1 | 0.60 | 0.065 | 29.0 | 671 | 1.8 | 3.4 | 7.5 | 0.065 | 7.2 |
| Ex. 1 | | 20 min | Crosslinker 2 | 0.20 | 0.067 | 26.8 | 661 | 1.8 | 3.3 | 6.8 | 0.063 | 7.2 |
| Ex. 2 | | | Crosslinker 2 | 0.60 | 0.068 | 23.1 | 692 | 1.7 | 2.9 | 5.9 | 0.068 | 7.2 |
| Ex. 3 | | | Crosslinker 2 | 1.20 | 0.068 | 20.3 | 722 | 1.5 | 2.5 | 4.7 | 0.066 | 7.0 |
| Ex. 4 | | | Crosslinker 2 | 4.00 | 0.066 | 19.6 | 710 | 1.6 | 2.6 | 4.8 | 0.066 | 6.9 |
| CE2 | A | 95° C.; | Crosslinker 1 | 0.60 | 0.071 | 27.3 | 690 | 1.7 | 2.9 | 6.1 | 0.067 | 6.9 |
| Ex. 1 | | 20 min | Crosslinker 2 | 0.20 | 0.068 | 26.7 | 693 | 1.7 | 2.9 | 5.9 | 0.065 | 6.7 |
| Ex. 2 | | | Crosslinker 2 | 0.60 | 0.069 | 28.3 | 687 | 1.7 | 3.0 | 6.3 | 0.065 | 7.0 |
| Ex. 3 | | | Crosslinker 2 | 1.20 | 0.069 | 28.1 | 682 | 1.7 | 3.0 | 6.6 | 0.066 | 7.9 |
| Ex. 4 | | | Crosslinker 2 | 4.00 | 0.067 | 26.2 | 686 | 1.7 | 3.0 | 6.7 | 0.065 | 6.5 |
| CE2 | A | 120° C.; | Crosslinker 1 | 0.60 | 0.068 | 27.8 | 713 | 1.6 | 2.8 | 5.5 | 0.065 | 7.2 |
| Ex. 1 | | 20 min | Crosslinker 2 | 0.20 | 0.068 | 29.8 | 696 | 1.7 | 2.9 | 6.1 | 0.065 | 7.3 |
| Ex. 2 | | | Crosslinker 2 | 0.60 | 0.069 | 28.1 | 689 | 1.6 | 2.9 | 6.3 | 0.065 | 7.2 |
| Ex. 3 | | | Crosslinker 2 | 1.20 | 0.070 | 29.5 | 685 | 1.7 | 3.1 | 6.9 | 0.065 | 7.7 |
| Ex. 4 | | | Crosslinker 2 | 4.00 | 0.066 | 28.5 | 630 | 1.8 | 3.6 | 8.7 | 0.065 | 8.3 |

TABLE 3
Aged results for compositions Ex. 1 to 4 and CE 2, 0 month elapsed compounded latEx.

| | | | Crosslinker | | ASTM D6319 | | | | | | EN 455 | |
|---|---|---|---|---|---|---|---|---|---|---|---|---|
| | Latex | Curing | | Parts | Thickness | TS | EB | Modulus | | | Thickness | FAB |
| Sample | Prep. | Condition | Type | (phr) | (mm) | (MPa) | (%) | 100 | 300 | 500 | (mm) | (N) |
| CE2 | A | 70° C.; | Crosslinker 1 | 0.60 | 0.071 | 36.7 | 694 | 1.9 | 3.5 | 7.7 | 0.065 | 9.2 |
| Ex. 1 | | 20 min | Crosslinker 2 | 0.20 | 0.069 | 34.9 | 694 | 1.8 | 3.3 | 7.3 | 0.064 | 8.8 |
| Ex. 2 | | | Crosslinker 2 | 0.60 | 0.074 | 36.0 | 691 | 1.8 | 3.2 | 7.1 | 0.072 | 8.9 |
| Ex. 3 | | | Crosslinker 2 | 1.20 | 0.072 | 36.2 | 686 | 1.8 | 3.3 | 7.5 | 0.067 | 8.7 |
| Ex. 4 | | | Crosslinker 2 | 4.00 | 0.073 | 33.8 | 609 | 2.1 | 4.4 | 11.8 | 0.065 | 8.5 |
| CE2 | A | 95° C.; | Crosslinker 1 | 0.60 | 0.073 | 34.4 | 702 | 1.6 | 2.9 | 6.1 | 0.067 | 8.6 |
| Ex. 1 | | 20 min | Crosslinker 2 | 0.20 | 0.070 | 36.0 | 707 | 1.7 | 3.1 | 6.4 | 0.068 | 8.0 |
| Ex. 2 | | | Crosslinker 2 | 0.60 | 0.071 | 34.8 | 698 | 1.7 | 3.0 | 6.8 | 0.068 | 9.6 |
| Ex. 3 | | | Crosslinker 2 | 1.20 | 0.072 | 36.2 | 689 | 1.8 | 3.3 | 7.3 | 0.070 | 9.4 |
| Ex. 4 | | | Crosslinker 2 | 4.00 | 0.067 | 33.9 | 644 | 1.8 | 3.5 | 8.7 | 0.068 | 9.5 |
| CE2 | A | 120° C.; | Crosslinker 1 | 0.60 | 0.072 | 35.0 | 700 | 1.6 | 3.0 | 6.5 | 0.062 | 8.7 |
| Ex. 1 | | 20 min | Crosslinker 2 | 0.20 | 0.070 | 35.5 | 706 | 1.6 | 3.0 | 6.2 | 0.062 | 8.7 |
| Ex. 2 | | | Crosslinker 2 | 0.60 | 0.069 | 36.0 | 715 | 1.6 | 3.0 | 6.5 | 0.061 | 7.9 |
| Ex. 3 | | | Crosslinker 2 | 1.20 | 0.070 | 33.5 | 689 | 1.7 | 3.0 | 6.8 | 0.063 | 9.2 |
| Ex. 4 | | | Crosslinker 2 | 4.00 | 0.069 | 34.3 | 607 | 2.0 | 4.2 | 11.8 | 0.061 | 8.9 |

TABLE 4
Unaged results for compositions Ex. 1 to 4 and CE 2, 1 month elapsed compounded latEx.

| | | | Crosslinker | | ASTM D6319 | | | | | | EN 455 | |
|---|---|---|---|---|---|---|---|---|---|---|---|---|
| | Latex | Curing | | Parts | Thickness | TS | EB | Modulus | | | Thickness | FAB |
| Sample | Prep. | Condition | Type | (phr) | (mm) | (MPa) | (%) | 100 | 300 | 500 | (mm) | (N) |
| CE2 | A | 70° C.; | Crosslinker 1 | 0.60 | 0.065 | 22.2 | 597 | 1.6 | 3.2 | 8.8 | 0.068 | 6.5 |
| Ex. 1 | | 20 min | Crosslinker 2 | 0.20 | 0.068 | 22.4 | 615 | 1.5 | 2.9 | 7.4 | 0.073 | 6.8 |
| Ex. 2 | | | Crosslinker 2 | 0.60 | 0.065 | 18.4 | 615 | 1.4 | 2.7 | 6.6 | 0.071 | 6.3 |
| Ex. 3 | | | Crosslinker 2 | 1.20 | 0.067 | 16.0 | 615 | 1.4 | 2.6 | 6.3 | 0.073 | 5.1 |
| Ex. 4 | | | Crosslinker 2 | 4.00 | 0.073 | 6.7 | 347 | 1.8 | 5.3 | - | 0.072 | 1.8 |
| CE2 | A | 95° C.; | Crosslinker 1 | 0.60 | 0.075 | 23.5 | 664 | 1.7 | 2.9 | 6.3 | 0.070 | 6.9 |
| Ex. 1 | | 20 min | Crosslinker 2 | 0.20 | 0.073 | 25.9 | 665 | 1.7 | 3.0 | 6.4 | 0.074 | 7.9 |
| Ex. 2 | | | Crosslinker 2 | 0.60 | 0.070 | 26.3 | 661 | 1.8 | 3.1 | 6.7 | 0.074 | 7.6 |
| Ex. 3 | | | Crosslinker 2 | 1.20 | 0.072 | 23.1 | 625 | 1.7 | 3.2 | 7.8 | 0.077 | 6.9 |
| Ex. 4 | | | Crosslinker 2 | 4.00 | 0.075 | 10.5 | 386 | 2.3 | 6.3 | - | 0.075 | 2.8 |
| CE2 | A | 120° C.; | Crosslinker 1 | 0.60 | 0.067 | 26.1 | 703 | 1.7 | 2.9 | 5.8 | 0.072 | 7.3 |
| Ex. 1 | | 20 min | Crosslinker 2 | 0.20 | 0.071 | 25.8 | 678 | 1.5 | 2.7 | 6.1 | 0.072 | 7.3 |
| Ex. 2 | | | Crosslinker 2 | 0.60 | 0.070 | 27.2 | 663 | 1.6 | 2.9 | 6.5 | 0.072 | 7.2 |
| Ex. 3 | | | Crosslinker 2 | 1.20 | 0.070 | 26.5 | 630 | 1.6 | 3.1 | 7.9 | 0.071 | 6.6 |
| Ex. 4 | | | Crosslinker 2 | 4.00 | 0.071 | 12.9 | 411 | 2.1 | 6.4 | - | 0.073 | 2.8 |

TABLE 5
Aged results for compositions Ex. 1 to 4 and CE 2, 1 month elapsed compounded latEx.

| | | | Crosslinker | | ASTM D6319 | | | | | | EN 455 | |
|---|---|---|---|---|---|---|---|---|---|---|---|---|
| | Latex | Curing | | Parts | Thickness | TS | EB | Modulus | | | Thickness | FAB |
| Sample | Prep. | Condition | Type | (phr) | (mm) | (MPa) | (%) | 100 | 300 | 500 | (mm) | (N) |
| CE2 | A | 70° C.; | Crosslinker 1 | 0.60 | 0.069 | 29.6 | 636 | 1.6 | 3.1 | 8.0 | 0.070 | 8.5 |
| Ex. 1 | | 20 min | Crosslinker 2 | 0.20 | 0.069 | 30.0 | 649 | 1.5 | 2.9 | 6.8 | 0.073 | 9.8 |
| Ex. 2 | | | Crosslinker 2 | 0.60 | 0.070 | 25.5 | 632 | 1.5 | 3.1 | 7.9 | 0.068 | 9.4 |
| Ex. 3 | | | Crosslinker 2 | 1.20 | 0.069 | 29.4 | 605 | 1.7 | 3.6 | 10.5 | 0.068 | 8.9 |
| Ex. 4 | | | Crosslinker 2 | 4.00 | 0.070 | 20.8 | 428 | 2.3 | 8.7 | - | 0.071 | 5.7 |
| CE2 | A | 95° C.; | Crosslinker 1 | 0.60 | 0.075 | 29.5 | 700 | 1.5 | 2.6 | 5.6 | 0.073 | 9.0 |
| Ex. 1 | | 20 min | Crosslinker 2 | 0.20 | 0.075 | 32.8 | 693 | 1.5 | 2.7 | 6.1 | 0.074 | 9.3 |
| Ex. 2 | | | Crosslinker 2 | 0.60 | 0.072 | 32.9 | 674 | 1.7 | 3.1 | 7.1 | 0.073 | 9.4 |
| Ex. 3 | | | Crosslinker 2 | 1.20 | 0.075 | 30.8 | 635 | 1.8 | 3.5 | 8.9 | 0.072 | 9.2 |
| Ex. 4 | | | Crosslinker 2 | 4.00 | 0.074 | 20.7 | 457 | 2.3 | 7.8 | - | 0.074 | 5.1 |
| CE2 | A | 120° C.; | Crosslinker 1 | 0.60 | 0.070 | 31.3 | 670 | 1.6 | 2.9 | 6.7 | 0.071 | 9.3 |
| Ex. 1 | | 20 min | Crosslinker 2 | 0.20 | 0.070 | 33.9 | 679 | 1.7 | 3.1 | 7.1 | 0.072 | 9.2 |
| Ex. 2 | | | Crosslinker 2 | 0.60 | 0.068 | 36.5 | 665 | 1.8 | 3.3 | 7.9 | 0.068 | 9.2 |
| Ex. 3 | | | Crosslinker 2 | 1.20 | 0.069 | 31.7 | 638 | 1.7 | 3.1 | 8.0 | 0.070 | 8.5 |
| Ex. 4 | | | Crosslinker 2 | 4.00 | 0.073 | 19.6 | 460 | 2.1 | 7.2 | - | 0.070 | 4.9 |

In Tables 2 to 5, a comparison is shown between Crosslinker 1 and variable content of Crosslinker 2 used for curing in the latex composition at 70, 95 and 120° C. for 20 min.

Table 2 and 3 demonstrate the tensile properties results of the 0 months elapsed compounded latex and it is visible that the use of Crosslinker 2 is comparable to Crosslinker 1 from low to high curing temperatures (70-120° C.). Crosslinker 2 can be used as low as 0.2 phr or as high as 4.0 phr without significant deterioration in tensile performance.

Table 4 and 5 demonstrate the tensile properties results of the 1 months elapsed compounded latex and it is visible, that even after 1 month of elapsed time, a similar trend is observed as for the 0 month elapsed compounded latex.

TABLE 6
Unaged results for CE1; Ex. 2 and CE 2 with 0 month elapsed pre-added Crosslinker 1 or 2.

| | Latex | | ASTM D6319 | | | | | | EN 455 | |
|---|---|---|---|---|---|---|---|---|---|---|
| | Composition | Curing | Thickness | TS | | Modulus | | | Thickness | FAB |
| Examples | Preparation | Condition | (mm) | (MPa) | EB (%) | 100 | 300 | 500 | (mm) | (N) |
| CE1 | C | 95° C.; | 0.061 | 33.5 | 624 | 2.3 | 4.8 | 12.5 | 0.058 | 6.3 |
| CE2 | B | 20 min | 0.071 | 27.3 | 690 | 1.7 | 2.9 | 6.1 | 0.067 | 6.9 |
| Ex. 2 | | | 0.069 | 28.3 | 687 | 1.7 | 3.0 | 6.3 | 0.065 | 7.0 |
| CE1 | C | 120° C.; | 0.065 | 28.0 | 641 | 1.9 | 3.7 | 8.9 | 0.063 | 7.7 |
| CE2 | B | 20 min | 0.068 | 27.8 | 713 | 1.6 | 2.8 | 5.5 | 0.065 | 7.2 |
| Ex. 2 | | | 0.069 | 28.1 | 689 | 1.6 | 2.9 | 6.3 | 0.065 | 7.2 |

TABLE 7
Aged results for CE1; Ex. 2 and CE 2 with 0 month elapsed pre-added Crosslinker 1 or 2.

| | Latex | | ASTM D6319 | | | | | | EN 455 | |
|---|---|---|---|---|---|---|---|---|---|---|
| | Composition | Curing | Thickness | TS | | Modulus | | | Thickness | FAB |
| Sample | Preparation | Condition | (mm) | (MPa) | EB (%) | 100 | 300 | 500 | (mm) | (N) |
| CE1 | C | 95° C.; | 0.057 | 36.3 | 535 | 2.8 | 6.7 | 24.3 | 0.058 | 7.8 |
| CE2 | B | 20 min | 0.073 | 34.4 | 702 | 1.6 | 2.9 | 6.1 | 0.067 | 8.6 |
| Ex. 2 | | | 0.071 | 34.8 | 698 | 1.7 | 3.0 | 6.8 | 0.068 | 9.6 |
| CE1 | C | 120° C.; | 0.066 | 29.1 | 582 | 2.2 | 4.8 | 13.5 | 0.066 | 8.0 |
| CE2 | B | 20 min | 0.072 | 35.0 | 700 | 1.6 | 3.0 | 6.5 | 0.062 | 8.7 |
| Ex. 2 | | | 0.069 | 36.0 | 715 | 1.6 | 3.0 | 6.5 | 0.061 | 7.9 |

TABLE 8
Unaged results for CE1; Ex. 2 and CE 2 with 3 months elapsed pre-added Crosslinker 1 or 2.

| | Latex | | ASTM D6319 | | | | | | EN 455 | |
|---|---|---|---|---|---|---|---|---|---|---|
| | Composition | Curing | Thickness | TS | | Modulus | | | Thickness | FAB |
| Sample | Preparation | Condition | (mm) | (MPa) | EB (%) | 100 | 300 | 500 | (mm) | (N) |
| CE1 | C | 95° C.; | 0.065 | 35.3 | 629 | 2.4 | 5.1 | 12.9 | 0.059 | 7.5 |
| CE2 | B | 20 min | 0.065 | 29.7 | 581 | 2.5 | 5.4 | 14.5 | 0.060 | 6.4 |
| Ex. 2 | | | 0.070 | 27.6 | 596 | 2.3 | 4.6 | 12.1 | 0.063 | 6.6 |
| CE1 | C | 120° C.; | 0.064 | 35.6 | 590 | 2.4 | 5.3 | 16.0 | 0.064 | 8.0 |
| CE2 | B | 20 min | 0.070 | 26.3 | 591 | 2.3 | 4.9 | 12.8 | 0.063 | 7.7 |
| Ex. 2 | | | 0.065 | 36.0 | 619 | 2.3 | 4.9 | 12.8 | 0.067 | 8.0 |

TABLE 9
Aged results for CE1; Ex. 2 and CE 2 with 3 months elapsed pre-added Crosslinker 1 or 2.

| | Latex | | ASTM D6319 | | | | | | EN 455 | |
|---|---|---|---|---|---|---|---|---|---|---|
| | Composition | Curing | Thickness | TS | | Modulus | | | Thickness | FAB |
| Sample | Preparation | Condition | (mm) | (MPa) | EB (%) | 100 | 300 | 500 | (mm) | (N) |
| CE1 | C | 95° C.; | 0.067 | 42.4 | 560 | 2.8 | 7.2 | 26.1 | 0.060 | 8.8 |
| CE2 | B | 20 min | 0.068 | 38.4 | 597 | 2.5 | 5.6 | 14.9 | 0.064 | 8.7 |
| Ex. 2 | | | 0.068 | 39.3 | 642 | 2.3 | 4.8 | 12.1 | 0.066 | 9.0 |
| CE1 | C | 120° C.; | 0.065 | 40.0 | 550 | 2.5 | 7.1 | 25.1 | 0.060 | 8.3 |
| CE2 | B | 20 min | 0.068 | 36.5 | 626 | 2.4 | 5.2 | 13.2 | 0.067 | 9.1 |
| Ex. 2 | | | 0.065 | 39.0 | 618 | 2.4 | 5.2 | 13.6 | 0.068 | 9.0 |

TABLE 10
Unaged results for CE1; Ex. 2 and CE 2 with 6 months elapsed pre-added Crosslinker 1 or 2.

| | Latex | | ASTM D6319 | | | | | | EN 455 | |
|---|---|---|---|---|---|---|---|---|---|---|
| | Composition | Curing | Thickness | TS | | Modulus | | | Thickness | FAB |
| Sample | Preparation | Condition | (mm) | (MPa) | EB (%) | 100 | 300 | 500 | (mm) | (N) |
| CE1 | C | 95° C.; | 0.060 | 34.4 | 604 | 3.0 | 6.0 | 14.1 | 0.061 | 8.0 |
| CE2 | B | 20 min | 0.059 | 28.5 | 568 | 2.9 | 5.9 | 15.4 | 0.060 | 6.8 |
| Ex. 2 | | | 0.060 | 27.4 | 599 | 2.6 | 5.1 | 12.0 | 0.060 | 6.6 |
| CE1 | C | 120° C.; | 0.058 | 38.9 | 565 | 3.1 | 6.9 | 19.9 | 0.055 | 8.1 |
| CE2 | B | 20 min | 0.059 | 31.3 | 588 | 2.8 | 5.8 | 14.6 | 0.058 | 6.8 |
| Ex. 2 | | | 0.062 | 31.1 | 614 | 2.4 | 4.8 | 11.0 | 0.055 | 7.9 |

TABLE 11
Aged results for CE1; Ex. 2 and CE 2 with 6 months elapsed pre-added Crosslinker 1 or 2.

| | Latex | | ASTM D6319 | | | | | | EN 455 | |
|---|---|---|---|---|---|---|---|---|---|---|
| | Composition | Curing | Thickness | TS | | Modulus | | | Thickness | FAB |
| Sample | Preparation | Condition | (mm) | (MPa) | EB (%) | 100 | 300 | 500 | (mm) | (N) |
| CE1 | C | 95° C.; | 0.063 | 37.0 | 533 | 2.8 | 7.0 | 27.7 | 0.066 | 8.7 |
| CE2 | B | 20 min | 0.065 | 33.4 | 592 | 2.5 | 5.6 | 14.6 | 0.066 | 8.5 |
| Ex. 2 | | | 0.066 | 39.0 | 589 | 2.5 | 5.5 | 15.8 | 0.066 | 8.9 |
| CE1 | C | 120° C.; | 0.062 | 34.8 | 544 | 2.7 | 6.3 | 22.7 | 0.061 | 8.7 |
| CE2 | B | 20 min | 0.065 | 33.1 | 612 | 2.4 | 5.0 | 12.7 | 0.061 | 8.1 |
| Ex. 2 | | | 0.061 | 35.0 | 615 | 2.2 | 4.7 | 12.1 | 0.061 | 8.6 |

In Tables 6 to 11, a comparison is shown between a sulphur-vulcanized polymer latex composition and polymer latex compositions using pre-added Crosslinker 1 or Crosslinker 2 (0 to 6 months of pre-addition), which are cured at 95 and 120° C. for 20 min. It is visible that the use of Crosslinker 1 and Crosslinker 2 have a slightly lower TS but higher EB than sulphur-vulcanized polymer latex at low (95° C.) and high (120° C.) curing temperature.

Surprisingly, the tensile properties of accelerator-free polymer latexes (CE2 & Ex.2) improved after aging. In comparison to sulphur-vulcanized polymer latex, both accelerator-free polymer latexes improved in both TS and EB, wherein the aged TS value is comparable to aged TS value of sulphur-vulcanized polymer latex.

Nonetheless, in the case of accelerator-free latex—the use of Crosslinker 2 is comparable to Crosslinker 1 cured polymer latex at 0.6 phr.

TABLE 12
Durability results of compositions Ex. 1 to 4 and CE
2, with 0 month and 1 month elapsed compounded latex.

| | | | | Elapsed Time After | |
|---|---|---|---|---|---|
| | | | | Adjusting | |
| | | | | Composition | |
| | | | | for Dip Molding; | |
| | Crosslinker | Crosslinker | Curing | Durability (hours) | |
| Examples | Added | Parts (phr) | Condition | 0 month | 1 month |
| CE2 | Crosslinker 1 | 0.60 | 70° C.; | 1.7 | 2.2 |
| Ex. 1 | Crosslinker 2 | 0.20 | 20 min | 1.1 | 2.2 |
| Ex. 2 | Crosslinker 2 | 0.60 | | 1.5 | 5.0 |
| Ex. 3 | Crosslinker 2 | 1.20 | | 1.5 | 5.0 |
| Ex. 4 | Crosslinker 2 | 4.00 | | 3.6 | 0.1 |
| CE2 | Crosslinker 1 | 0.60 | 95° C.; | 3.5 | 4.3 |
| Ex. 1 | Crosslinker 2 | 0.20 | 20 min | 2.4 | 3.0 |
| Ex. 2 | Crosslinker 2 | 0.60 | | 3.0 | 5.0 |
| Ex. 3 | Crosslinker 2 | 1.20 | | 4.6 | 5.0 |
| Ex. 4 | Crosslinker 2 | 4.00 | | 5.0 | 0.5 |
| CE2 | Crosslinker 1 | 0.60 | 120° C.; | 5.0 | 5.0 |
| Ex. 1 | Crosslinker 2 | 0.20 | 20 min | 5.0 | 5.0 |
| Ex. 2 | Crosslinker 2 | 0.60 | | 5.0 | 5.0 |
| Ex. 3 | Crosslinker 2 | 1.20 | | 5.0 | 5.0 |
| Ex. 4 | Crosslinker 2 | 4.00 | | 5.0 | 1.1 |

TABLE 13
Durability results of composition CE1; and compositions
Ex. 2 and CE 2 with 0 month, 3 months and 6 months
elapsed pre-added Crosslinker 1 or 2.

| | | Elapsed Time After Adjusting Composition | | |
|---|---|---|---|---|
| | Curing | for Dip Molding; Durability (hours) | | |
| Examples | Condition | 0 month | 3 months | 6 months |
| CE1 | 95° C.; | 0.7 | 1.4 | 2.5 |
| CE2 | 20 min | 3.5 | 0.7 | 0.9 |
| Ex. 2 | | 3.0 | 3.9 | 5.0 |
| CE1 | 120° C.; | 5.0 | 5.0 | 5.0 |
| CE2 | 20 min | 5.0 | 1.7 | 1.9 |
| Ex. 2 | | 5.0 | 5.0 | 4.6 |

In Table 12, durability fatigue results are shown of examples CE2 with Crosslinker 1 (0.6 phr), Ex. 1 to Ex. 4 of increasing Crosslinker 2 content (0.2-4.0 phr). Surprisingly, all examples meet the preferable 1 hour or more fatigue durability except for Ex.4 with 4.0 phr of Crosslinker 2 after 1-month elapsed time period cured at 70 and 95° C. for 20 min. It is visible that high fatigue durability is maintained even after 1 month of elapsed time. Therefore, the pot-life of selective compositions comprising Crosslinker 1 or Crosslinker 2 may be up to 1 month, wherein the content of Crosslinker 2 may be as low as 0.2 parts.

In Table 13, durability fatigue results of examples CE1, CE2 and Ex.2 are shown. CE1 is a sulphur-vulcanized polymer latex composition which is compounded and used immediately without pre-addition. CE2 and Ex.2 are accelerator-free polymer latex composition with pre-addition (0-6 months) of either Crosslinker 1 or Crosslinker 2, which are then compounded and used. CE1, sulphur-vulcanized polymer latex composition requires high curing temperature of 120° C. to achieve high durability. For CE2 and Ex.2, accelerator-free polymer latex composition, significant reduction of fatigue durability for CE2 which uses Crosslinker 1 is observed. For CE2, after 3 months of pre-addition with low temperature curing of 95° C., the preferable 1 hour or more fatigue durability cannot be achieved. In comparison, only Ex.2 using Crosslinker 2 can maintain its high fatigue durability up to 6 months, either cured at 95 or 120° C. for 20 min.

1. A polymer latex composition for the preparation of elastomeric films comprising:
(a) particles of a latex polymer obtained by free-radical emulsion polymerization of a composition comprising ethylenically unsaturated monomers, the latex polymer comprising a functional group (A); and
(b) a silane compound selected from the compounds of Formula I, II, oligomers thereof or combinations of any of the foregoing: 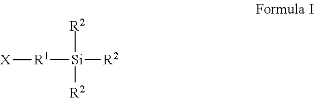
wherein
X is a functional group capable to form a bond with the functional group (A) of the latex polymer (a);
R¹ is a linking group between the functional group X and the silicon atom or R¹ is a bond;
R² independently is a hydrolysable group or a non-hydrolysable group;
at least one of R² is a hydrolysable group and at least one of R² is a non-hydrolysable group; 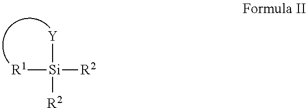
wherein
Y is O, S, NH or NR³; wherein R³ is a linear or branched, substituted or unsubstituted alkyl or alkenyl;
R¹ is a linking group between the functional group Y and the silicon atom;
R² independently is a hydrolysable group or a non-hydrolysable group;
at least one of R² is a non-hydrolysable group.

2. (canceled)

3. The polymer latex composition according to claim 1, comprising the silane compound (b) in an amount of from 0.10 to 4.00 parts by weight based on 100 parts by weight of latex polymer (a).

4. The polymer latex composition according to claim 1, wherein each non-hydrolysable R² independently is a linear C₁ to C₂₀ alkyl, a linear C₂-C₂₀ alkenyl, a branched or cyclic C₃-C₂₀ alkyl or alkenyl or an aryl.

5. The polymer latex composition according to claim 1, wherein each hydrolysable R² independently is —H, —OR′, —OC(O)CH₃, —OCH₂OCH₃, —SR′, —NHR′, —NR′₂, -halogen, wherein R′ is a linear C₁-C₆ alkyl, a branched C₃-C₆ alkyl or alkenyl, or an aryl.

6. The polymer latex composition according to claim 1, wherein the linking group R¹ between the functional group X and the silicon atom is a linear C₁-C₂₀ alkanediyl, a branched C₂-C₂₀ alkanediyl, a cyclic C₃-C₂₀ alkanediyl or alkenediyl, or arylenediyl; preferably a linear C₁-C₂₀ alkanediyl, wherein optionally one or more methylene group(s) in each of the above alkanediyl, alkenediyl and arylenediyl is/are replaced by a heteroatom, provided that no heteroatom is directly bonded to another heteroatom and no heteroatom is directly bonded to Si.

7. (canceled)

8. The polymer latex composition according to claim 1, wherein the functional group X is selected from the group consisting of carbon-carbon double bond, (meth)acryloxy, halide functional group, epoxy, glycidyl, thiol, hydroxy, hydroxylamine, primary amino, secondary amino, isocyanato, oxazolino, aziridino, imino, carbodiimido, glycol, ester, acetoxy, acetoacetoxy, carboxylic acid, dioxolanone, hydrazido, aldehyde, boronic acid, alkoxysilyl and ketone.

9. The polymer latex composition according to claim 1, wherein the silane compound (b) is selected from the group consisting of (3-glycidoxypropyl) methyl diethoxysilane, (3-glycidoxypropyl) dimethyl ethoxysilane, (3-glycidoxypropyl) methyl dimethoxysilane, 2-(3,4-epoxycyclohexyl)ethyl methyl diethoxysilane, 3-aminopropyl dimethyl methoxysilane, 3-aminopropyl dimethyl ethoxysilane, 3-aminopropyl methyl diethoxysilane, 3-aminopropyl diisopropyl ethoxysilane, 4-amino-3,3-dimethylbutyl methyl dimethoxysilane, (1-aminopropan-2-yl) ethoxy dimethylsilane, N-(2-aminoethyl)-3-aminopropyl methyl diethoxysilane, N-(2-aminoethyl)-3-aminoisobutyl dimethyl methoxysilane, N-(2-aminoethyl)-3-aminopropyl methyl dimethoxysilane, N-(2-aminoethyl)-3-aminoisobutyl methyl dimethoxysilane, (N-cyclohexylaminomethyl) methyl diethoxysilane, N-methylaminopropyl methyl dimethoxysilane, (phenylaminomethyl) methyl dimethoxysilane, 3-(N,N-dimethylaminopropyl)aminopropyl methyl dimethoxysilane, (3-acryloxypropyl) methyl diethoxysilane, (3-acryloxypropyl) methyl dimethoxysilane, (3-acryloxypropyl) dimethyl methoxysilane, (methacryloxymethyl) methyl diethoxysilane, (methacryloxymethyl) methyl dimethoxysilane, (methacryloxymethyl) dimethyl ethoxysilane, (methacryloxypropyl) dimethyl methoxysilane, allylmethyldimethoxysilane, vinylmethyldiethoxysilane, vinylmethyldimethoxysilane, vinyldimethylethoxysilane, (5-bicyclo[2.2.1]hept-2-enyl) methyl diethoxysilane, (5-bicyclo[2.2.1]hept-2-enyl) dimethyl ethoxysilane, (5-bicyclo[2.2.1]hept-2-enyl) methyl dichlorosilane, (mercaptomethyl) methyl diethoxysilane, 3-mercaptopropyl methyl dimethoxysilane, chloromethyl dimethyl ethoxysilane, ((chloromethyl)phenylethyl) methyl dimethoxysilane, 3-chloropropyl dimethyl ethoxysilane, 3-chloropropyl dimethyl methoxysilane, 3-chloroisobutyl dimethyl methoxysilane, chloromethyl dimethyl ethoxysilane, 3-chloropropyl methyl diisopropoxysilane, (3-iodopropyl) methyl diisopropoxysilane, 3-isocyanatopropyl methyl diethoxysilane, 3-isocyanatopropyl methyl dimethoxysilane, 1,1-dimethyl-1-sila-2-oxacyclohexane, 2,2,4-trimethyl-1-oxa-4-aza-2-silacyclohexane, 1-decyl-1-methyl-1-sila-2-oxacyclohexane, 2,2,4-trimethyl-1-thia-2-silacyclopentane, N-(2-aminoethyl)-2,2,4-trimethyl-1-aza-2-silacyclopentane, N-(3-aminopropyldimethylsilyl)aza-2,2-dimethyl-2-silacyclopentane, (N,N-dimethylaminopropyl)-aza-2-methyl-2-methoxysilacyclopentane, and combinations thereof.

10. The polymer latex composition according to claim 1, wherein the functional group (A) of the latex polymer (a) is selected from the group consisting of carbon-carbon double bond, carboxylic acid, hydroxy, epoxy, glycidyl, acetoacetoxy, primary or secondary amino, acetoxy, isocyanato, alkoxysilyl, alkoxy, dioxolanone, halide functional group, thiol, hydroxylamine, oxazolino, aziridino, imino, carbodiimido, glycol, ester, hydrazido, aldehyde, ketone, and combinations thereof.

11. (canceled)

12. (canceled)

13. The polymer latex composition according to claim 1, further comprising a silane compound (c) different to silane compound (b), wherein silane compound (c) is selected from the compounds of Formula III, IV, oligomers thereof or combinations of any of the foregoing: 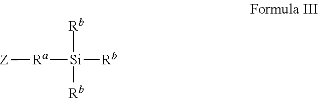
wherein
Z is a functional group capable to form a bond with the functional group (A) of the latex polymer (a);
R^{a} is a linking group between the functional group Z and the silicon atom or R^{a} is a bond;
R^{b} is a hydrolysable group; 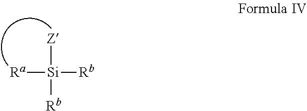
wherein
Z′ is O, S, NH or NR³; wherein R³ is a linear or branched, substituted or unsubstituted alkyl or alkenyl;
R^{a} is a linking group between the functional group Z′ and the silicon atom;
R^{b} is a hydrolysable group.

14. The polymer latex composition according to claim 13, wherein the Si—Z′ bond is hydrolysable forming a Si—OH group and a Z′—H group, wherein the Z′—H group is a functional group capable to form a bond with the functional group (A) of the latex polymer (a).

15. The polymer latex composition according to claim 13, wherein each hydrolysable R^{b} independently is —H, —OR′, —OC(O)Me, —OCH₂OCH₃, —SR′, —NHR′, —NR′₂, -halogen, wherein R′ is a linear C₁-C₆ alkyl, a branched C₃-C₆ alkyl or alkenyl, or an aryl;
wherein the linking group R^{a} between the functional group Z and the silicon atom is a linear C₁-C₂₀ alkanediyl, a branched C₂-C₂₀ alkanediyl, a cyclic C₃-C₂₀ alkanediyl or alkenediyl, or arylenediyl, wherein optionally one or more methylene group(s) in each of the above alkanediyl, alkenediyl and arylenediyl is/are replaced by a heteroatom, provided that no heteroatom is directly bonded to another heteroatom and no heteroatom is directly bonded to Si;
wherein the linking group R^{a} between the functional group Z′ and the silicon atom is a linear or branched C₃-C₂₀ alkanediyl, wherein optionally one or more methylene group(s) in each of the above alkanediyl, alkenediyl and arylenediyl is/are replaced by a heteroatom, provided that no heteroatom is directly bonded to another heteroatom and no heteroatom is directly bonded to Si; and
wherein the functional group Z is selected from the group consisting of carbon-carbon double bond, (meth)acryloxy, halide functional group, epoxy, glycidyl, thiol, hydroxy, hydroxylamine, primary amino, secondary amino, isocyanato, oxazolino, aziridino, imino, carbodiimido, glycol, ester, acetoxy, acetoacetoxy, carboxylic acid, dioxolanone, hydrazido, aldehyde, boronic acid, alkoxysilyl and ketone.

16. (canceled)

17. (canceled)

18. The polymer latex composition according to claim 1, wherein the monomer composition to obtain the particles of a latex polymer (a) comprises:
(i) 15 to 99 wt.-% of conjugated dienes;
(ii) 1 to 80 wt.-% of monomers selected from ethylenically unsaturated nitrile compounds;
(iii) 0 to 10 wt.-% of an ethylenically unsaturated compound different from (i) and (ii) comprising a functional group (A);
(iv) 0 to 80 wt.-% of vinyl aromatic monomers; and
(v) 0 to 65 wt.-% of alkyl esters of ethylenically unsaturated acids;
the weight percentages being based on the total weight of the ethylenically unsaturated monomers in the monomer composition.

19. The polymer latex composition according to claim 18, wherein
(i) the conjugated dienes are selected from 1,3-butadiene, isoprene, 2,3-dimethyl-1,3-butadiene, 2-ethyl-1,3-butadiene, 1,3-pentadiene, 3,7,11-trimethyl-1,3,6,10-dodecatetraene, 7,11-dimethyl-3-methylene-1,6,10-dodecatriene, 7-methyl-3-methylene-1,6-octadiene, and combinations thereof;
(ii) the ethylenically unsaturated nitrile compounds are selected from (meth)acrylonitrile, alpha-cyanoethyl acrylonitrile, fumaronitrile, alpha-chloronitrile and combinations thereof;
(iii) the ethylenically unsaturated compounds different from (i) and (ii) comprising a functional group (A) are selected from
(iii1) ethylenically unsaturated compounds having at least two different ethylenically unsaturated groups;
(iii2) ethylenically unsaturated acids and salts thereof;
(iii3) hydroxy functional ethylenically unsaturated compounds;
(iii4) epoxy functional ethylenically unsaturated compounds;
(iii5) glycidyl functional ethylenically unsaturated compounds;
(iii6) acetoacetoxy functional ethylenically unsaturated compounds;
(iii7) ethylenically unsaturated compounds bearing a primary or secondary amino group;
(iii8) acetoxy functional ethylenically unsaturated compounds;
(iii9) isocyanato functional ethylenically unsaturated compounds;
(iii10) alkoxysilyl functional ethylenically unsaturated compounds;
(iii11) alkoxy functional ethylenically unsaturated compounds;
(iii12) dioxolanone functional ethylenically unsaturated compounds;
(iii13) halide functional ethylenically unsaturated compounds;
(iii14) thiol functional ethylenically unsaturated compounds;
(iii15) hydroxylamine functional ethylenically unsaturated compounds;
(iii16) oxazolino functional ethylenically unsaturated compounds;
(iii17) aziridino functional ethylenically unsaturated compounds;
(iii18) imino functional ethylenically unsaturated compounds;
(iii19) carbodiimino functional ethylenically unsaturated compounds;
(iii20) glycol functional ethylenically unsaturated compounds;
(iii21) hydrazido functional ethylenically unsaturated compounds;
(iii22) aldehyde functional ethylenically unsaturated compounds;
(iii23) ketone functional ethylenically unsaturated compounds;
and combinations thereof;
(iv) the vinyl aromatic monomers are selected from styrene, alpha-methyl styrene and combinations thereof;
(v) alkyl esters of ethylenically unsaturated acids are selected from methyl (meth)acrylate, ethyl (meth)acrylate, propyl (meth)acrylate, butyl (meth)acrylate, 2-ethylhexyl (meth)acrylate, and combinations thereof;
and combinations thereof.

20. (canceled)

21. A method for preparing a polymer latex composition comprising:
(i) polymerizing in an emulsion polymerization process a monomer composition comprising ethylenically unsaturated monomers for latex polymer (a) comprising at least one monomer resulting after polymerization in a functional group (A) to obtain a latex comprising particles of latex polymer (a) comprising functional groups (A); and
(ii) adding a silane compound (b) selected from the compounds of Formula I, II, oligomers thereof or combinations of any of the foregoing: 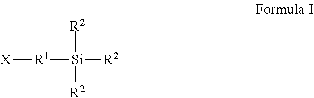
wherein
X is a functional group capable to form a bond with the functional group (A) of the latex polymer (a);
R¹ is a linking group between the functional group X and the silicon atom or R¹ is a bond;
R² independently is a hydrolysable group or a non-hydrolysable group;
wherein at least one of R² is a hydrolysable group and at least one of R² is a non-hydrolysable group; 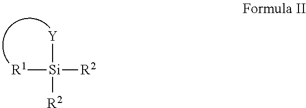
wherein
Y is O, S, NH or NR³; wherein R³ is a linear or branched, substituted or unsubstituted alkyl or alkenyl;
R¹ is a linking group between the functional group Y and the silicon atom;
R² independently is a hydrolysable group or a non-hydrolysable group;
wherein at least one of R² is a non-hydrolysable group; and
(iii) optionally adding a silane compound (c) different to silane compound (b), wherein silane compound (c) is selected from the compounds of Formula III, IV, oligomers thereof or combinations of any of the foregoing: 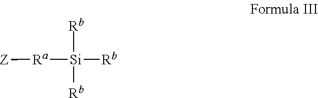
wherein
Z is a functional group capable to form a bond with the functional group (A) of the latex polymer (a);
R^{a} is a linking group between the functional group Z and the silicon atom or R^{a} is a bond;
R^{b} is a hydrolysable group; 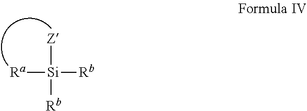
wherein
Z′ is O, S, NH or NR³; wherein R³ is a linear or branched, substituted or unsubstituted alkyl or alkenyl;
R^{a} is a linking group between the functional group Z′ and the silicon atom;
R^{b} is a hydrolysable group.

22. (canceled)

23. (canceled)

24. A compounded polymer latex composition suitable for the production of dip-molded articles comprising the polymer latex composition according to claim 1 and optionally adjuvants selected from sulfur vulcanization agents, accelerators for vulcanization, free-radical initiators, pigments and combinations thereof, and optionally comprising polyvalent cations and/or silica-based fillers.

25. A method for making dip-molded articles by
(a) providing a compounded latex composition according to claim 24;
(b) immersing a mold having the desired shape of the final article in a coagulant bath comprising a solution of a metal salt;
(c) removing the mold from the coagulant bath and optionally drying the mold;
(d) immersing the mold as treated in step b) and c) in the compounded latex composition of step a);
(e) coagulating a latex film on the surface of the mold;
(f) removing the latex-coated mold from the compounded latex composition and optionally immersing the latex-coated mold in a water bath;
(g) optionally drying the latex-coated mold;
(h) heat treating the latex-coated mold obtained from step e) or f) at a temperature of 40° C. to 180° C.; and/or exposing the latex-coated mold obtained from step e) or f) to UV radiation;
(i) removing the latex article from the mold.

26. A method for the production of a continuous elastomeric film comprising:
(A) providing a polymer latex composition as defined in claim 1;
(B) forming from the aqueous polymer latex composition a continuous polymer film;
(C) optionally drying the continuous polymer film obtained in step B);
(D) heat treating the continuous polymer film obtained in step B) or C) at a temperature of 40° C. to 180° C. preferably for 20 min or less to form a continuous elastomeric film; and/or UV treating, and
(E) optionally rolling the continuous elastomeric film obtained in step D) into a roll.

27-29. (canceled)

30. A method for repairing or reforming an elastomeric film or an article comprising said elastomeric film by
a) providing a film or article comprising an elastomeric film or films, having at least two surfaces to be reconnected,
b) re-joining the at least two surfaces of the elastomeric film(s), and heating or annealing the elastomeric film(s) while maintaining intimate contact of the rejoined surfaces of the damaged film at a temperature of 40 to 200° C., wherein
c) the elastomeric film is made from a polymer latex composition as defined in claim 1.

31. An article made by using the polymer latex composition as defined in claim 1.

32. The article of claim 31, being selected from surgical gloves, examination gloves, industrial gloves, household gloves, single-use gloves, textile supported gloves, catheters, elastomeric sleeves, condoms, balloons, tubing, dental dam, apron and pre-formed gasket.
